(19) United States
(12) Patent Application Publication
(10) Pub. No.: US 2019/0220851 A1
(43) Pub. Date: Jul. 18, 2019

(54) EVENT BASED PAYMENT-PROCESSING SYSTEM

(71) Applicant: VOUCHR LTD., Toronto (CA)

(72) Inventors: Aaron BARNES, Toronto (CA); Robert BALAHURA, Toronto (CA); Suresh BHAT, Toronto (CA)

(21) Appl. No.: 16/249,644

(22) Filed: Jan. 16, 2019

Related U.S. Application Data
(60) Provisional application No. 62/617,726, filed on Jan. 16, 2018.

(51) Int. Cl. G06Q 20/36; G06Q 20/34; G06Q 20/32; G07F 17/32

(52) U.S. Cl. CPC G06Q 20/3672; G07F 17/3251; G06Q 20/3224; G06Q 20/351

(57) ABSTRACT

Disclosed herein are systems and methods for processing a gift request that use mobile computing devices to transfer a gift payment associated with the gift request. The mobile computing devices are capable of running a gift transfer application, which facilitates a transfer of the gift payment via a payment-processing server. A sender user execute the gift transfer application, using a mobile computing device, to transfer the gift payment, through a gift processing system that runs the gift transfer application, to a mobile computing device of a recipient user. One or more techniques authenticate the recipient user prior to processing the gift requests initiated by the sender user.

### CROSS REFERENCE TO RELATED APPLICATIONS

This application claims priority to U.S. Provisional Patent Application Ser. No. 62/617,726, filed Jan. 16, 2018, which is incorporated herein in its entirety.

### TECHNICAL FIELD

This application relates generally to the field of automated payment-processing systems, and more specifically to methods and systems for executing payment-processing for a variety of payment methods upon occurrence of events.

### BACKGROUND

Gift cards have become popular gifts. The gift cards typically include a stored value card whereby a certain cash equivalent value is encoded upon a magnet strip applied to the surface of the card. The stored value may be determined by a vendor prior to packaging and display for sale or, more commonly, is selected at the point of sale by the purchaser and loaded by the cashier using a magnet card reader/writer. A user that purchases the gift cards for friends and family members must send the gift cards via email or post. Also, when two or more users want to send a gift card to a same individual, the two or more users have to separately purchase and send the gift cards to the individual. The conventional gift card delivery methods are passive in nature where a gift giver neither has any interaction with a receiver of the gift nor any control over the gift giving experience.

### SUMMARY

What is therefore needed is an efficient, a secure, and an interactive technique for online transfer of a gift (e.g., a payment amount and a media element) from a computing device of a sender user to a recipient user, in response to an execution of a task (e.g., a challenge, an action, an occurrence of an event, or other trigger) at a computing device of the recipient user. In one configuration, when the recipient user accomplishes the task, a software application on the computing device of the recipient user will display a gift message. The gift message may include information associated with the transfer of the payment amount. For any payment amount transmitted to the recipient user from the sender user in a peer-to-peer system, the system may deduct the funds corresponding to the payment amount from a bank account of the sender user when the sender user initiates the transfer process, however a bank account of the recipient user does not receive the payment amount until the recipient user accomplishes the task.

In another configuration, a gift may be a digital gift card. When the digital gift card is purchased by the sender user for the recipient user, the digital gift card may not contain any money until and unless the recipient user accomplishes the task, thereby allowing the sender user and other users authorized by the sender user to later on add money in the digital gift card. In such a configuration, a message displayed on the computing device of the recipient user in response to the successful completion of the task, which may originate from multiple senders, may contain various multimedia elements all sent in a single message (e.g., via SMS or other messaging application). Upon activating a web link associated with the message, all of the multimedia elements within the message may be displayed on a graphical user interface of the computing device of the recipient user such that the multimedia elements are shown on a single screen, e.g., in a scrolling manner to appear as though the multimedia elements are coming from a depiction of an envelope.

In one embodiment, a method may include receiving, by a server from a first application executing on a first mobile device, a request to transmit an electronic group message comprising at least a payment transfer request to a second mobile device, the payment transfer request comprising a first payment amount, a first payment account of the first user, a first media element, and a first payment criterion where payment of the payment amount is dependent upon satisfaction of the first criteria, the payment transfer further comprising communication identifier of a third mobile device; transmitting, by the server using a second application executing on the second mobile device, the electronic group message to the third mobile device, whereby the third mobile device updates the electronic group message by transmitting a second payment amount, a second payment account of the third user, a second media element, and a second payment criterion where payment of the payment amount is dependent upon satisfaction of the first criteria and the second criterion; generating, by the server, a unique transaction token corresponding to the electronic message; upon withdrawing funds corresponding to the first and second payment amounts from the first and second payment accounts respectively, initiating a transfer of the funds to an escrow account; transmitting, by the server using a third application executing on the second mobile device, the electronic group message and the unique transaction token to the second computing device, wherein the server displays the first and the second media elements in a predetermined order; and upon the second mobile device satisfying the first and second criteria, instructing the second computing device to transmit the unique transaction token to a payment server associated with the first and second payment accounts, whereby the payment server initiates a transfer of the funds from the escrow account to a third payment account of the second mobile device, upon successful matching of the unique transaction token received from the server and the second computing device.

In another embodiment, a method may include receiving, by a server, a request from a first computing device operated by a first user to transmit an electronic message comprising at least a payment transfer request to a second computing device of a second user, the payment transfer request comprising a payment amount, a payment account of the first user, and a location-based criteria where payment of the payment amount is dependent upon a satisfaction of the location-based criteria; generating, by the server, a unique transaction token corresponding to the electronic message; upon withdrawing funds corresponding to the payment amount from the payment account of the first user, initiating a transfer of the funds to an escrow account; upon transmitting the electronic message and the unique transaction token to the second computing device, monitoring, by the server, location of the second computing device; upon a location of the second computing device satisfying the location-based criteria, instructing the second computing device to transmit the unique transaction token to a payment server associated with the payment account, whereby the payment server initiates a transfer of the funds from the escrow account to a payment account of the second user upon successful matching of the unique transaction token received from the server and the second computing device.

In yet another embodiment, a method may include receiving, by the server, a first request from a first mobile device of a first user to transmit a first electronic message to a recipient mobile device, the first electronic message comprising at least a first payment transfer request to the computing device, the first payment transfer request comprising a first payment amount, a first media element, and a first payment criterion where a payment of the first payment amount is dependent upon a satisfaction of the first payment criteria; receiving, by the server, a second request, from a second mobile device to transmit message second electronic message comprising at least a second payment transfer request to the recipient mobile device, the second payment transfer request comprising a second payment amount, a second media element, and a second payment criterion where a payment of the second payment amount is dependent upon satisfaction of the second payment criteria; and transmitting, by a server, a group electronic message to the recipient mobile device, wherein the group electronic message comprises the first electronic message and the second electronic message displayed in a predetermined order on a graphical user interface of the recipient mobile device, and wherein the group electronic message displays a graphical indicator for the first payment criteria and the second payment criteria, and wherein a recipient user operating the recipient mobile device scrolls the first media elements and the second media element on the graphical user interface.

### BRIEF DESCRIPTION OF THE DRAWINGS

The accompanying drawings constitute a part of this specification and illustrate embodiments of the subject matter disclosed herein.

FIG. 1 illustrates a system for processing gift payments, according to an embodiment.

FIG. 2 illustrates an example of a process for processing gift payments using a gift transfer application on a computing device, according to an embodiment.

FIG. 3A illustrates a GUI for presenting gift generation process when a user is accessing gift transfer application on a first computing device, according to an embodiment.

FIG. 3B illustrates a GUI for presenting gift generation process when a user is accessing gift transfer application on a first computing device, according to an embodiment.

FIG. 3C illustrates a GUI for presenting gift generation process when a user is accessing gift transfer application on a first computing device, according to an embodiment.

FIG. 4A illustrates a GUI for presenting gift acceptance process when a user is accessing gift transfer application on a second computing device, according to an embodiment.

FIG. 4B illustrates a GUI for presenting gift acceptance process when a user is accessing gift transfer application on a second computing device, according to an embodiment.

FIG. 4C illustrates a GUI for presenting gift acceptance process when a user is accessing gift transfer application on a second computing device, according to an embodiment.

FIG. 5A illustrates a GUI for presenting gift generation process when a user is accessing gift transfer application on a first computing device, according to an embodiment.

FIG. 5B illustrates a GUI for presenting gift generation process when a user is accessing gift transfer application on a first computing device, according to an embodiment.

FIG. 6A illustrates a GUI for presenting gift generation process when a user is accessing gift transfer application on a second computing device, according to an embodiment.

FIG. 6B illustrates a GUI for presenting gift generation process when a user is accessing gift transfer application on a second computing device, according to an embodiment.

FIG. 6C illustrates a GUI for presenting gift generation process when a user is accessing gift transfer application on a second computing device, according to an embodiment.

FIG. 7 illustrates a GUI for presenting gift acceptance process when a user is accessing gift transfer application on a third computing device, according to an embodiment.

FIG. 8 illustrates a GUI of the gift transfer application on a mobile device of a sender where the sender has indicated a location based trigger or payment condition, according to an embodiment.

FIG. 9 illustrates a GUI of the gift transfer application on a mobile device of a sender where the sender has indicated a game-based trigger or payment condition, according to an embodiment.

FIG. 10 illustrates a GUI of the gift transfer application on a mobile device of a sender where the mobile application invokes other applications to provide payment options to the sender, according to an embodiment.

FIG. 11 illustrates a GUI of the gift transfer application on a mobile device of a recipient where the recipient can create a wish list of desired gifts, according to an embodiment.

FIG. 12 illustrates a GUI of the gift transfer application on a mobile device of a sender where the sender can purchase media elements to be added to the gift message via an in-app purchase, according to an embodiment.

FIG. 13 illustrates a GUI of the gift transfer application on a mobile device of a sender where the sender has selected a coupon as the gift or payment to be transferred, according to an embodiment.

FIG. 14 illustrates a GUI of the gift transfer application on a mobile device of a sender or the recipient where the sender has indicated a location based trigger or condition for payment, according to an embodiment.

FIG. 15 illustrates a GUI of the gift transfer application displaying gift card registration, according to an embodiment.

FIG. 16 illustrates a GUI of the gift transfer application displaying a sender's information, according to an embodiment.

FIG. 17 illustrates a GUI of the gift transfer application on a mobile device of a sender where the sender has indicated a challenge to be completed by the recipient as a payment condition, according to an embodiment.

FIG. 18 illustrates a GUI of the gift transfer application on a mobile device of a recipient where the sender has indicated a game challenge as a payment condition, according to an embodiment.

FIG. 19 illustrates a GUI of the gift transfer application on a mobile device of a recipient where the sender has indicated a game challenge as a payment condition, according to an embodiment.

FIG. 20 illustrates a GUI of the gift transfer application on a mobile device of a recipient where the sender has indicated a time-based trigger or condition for payment, according to an embodiment.

FIG. 21 illustrates a GUI of the gift transfer application on a mobile device of a recipient displaying a total transaction amount, according to an embodiment.

FIG. 22 illustrates a GUI of the gift transfer application on a mobile device of a recipient where the sender has indicated a time-based trigger or condition for payment, according to an embodiment.

FIG. 23 illustrates a GUI of the gift transfer application on a mobile device of a sender where the sender can select multiple multimedia elements to be added to the gift message, according to an embodiment.

FIG. 24 illustrates a GUI of the gift transfer application on a mobile device of a sender where the sender may invoke another application executing on the sender's mobile device and transmit a gift card to a recipient, according to an embodiment.

FIG. 25 illustrates the gift transfer application transmitting the gift message to a messaging application executing on the sender's mobile device, according to an embodiment.

FIG. 26 illustrates a GUI of the gift transfer application on a mobile device of a recipient displaying different multimedia elements of the gift message, according to an embodiment.

FIG. 27 illustrates a GUI of the gift transfer application on a mobile device of a recipient displaying different multimedia elements of the gift message as augmented reality, according to an embodiment.

FIG. 28 illustrates a GUI of the gift transfer application on a mobile device of a recipient displaying different multimedia elements of the gift message as augmented reality, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here. Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein.

A computing device may execute a first software application (such as a gift transfer application), which facilitates transfer of electronic messages between devices of two or more users. The electronic messages may include a payment (e.g., transfer of funds or provision of a gift card) between the users. The computing device may also execute a second software application, which facilitates the transfer of the electronic messages and the payments (such as a payment or a gift card) between accounts of the two or more users via a payment transfer application (such as PayPal™) associated with the gift transfer application. A sender user can command the software application running on the computing device to send a payment or a gift card to a recipient user via a processing system that hosts the software application. The processing system may be associated with a payment-processing system that runs the payment transfer application, and provides instructions to the payment-processing system to deduct the gift amount from an account associated with the sender user (e.g., digital wallet or a bank account of the sender user), and then send the payment or the gift card to a recipient account (e.g., transfer funds to an account associated with the recipient, such as bank account, digital wallet, virtual gift card, pre-paid card, stored value card, and the like) associated with the recipient user.

Although the software application described herein is taking a form of a messaging application on a computing device, it should be appreciated that some embodiments are not limited to such a form factor. For instance, in some cases, users may access the processing system and services via a website, where the processing system may include a webserver in communication with an application server configured to perform the various processes and the tasks described herein. The user may access the processing system through a native software application (e.g., payment transfer application) installed on the user's local computer device that was downloaded from a server of the processing system. Additionally or alternatively, the user may access the processing system through an Internet browser application through which the user may provide various instructions to a webserver associated with a gift processing system. Other embodiments of the gift transfer application may include a messaging application executed by a computing device through which the user interfaces with the gift processing system via a chat messaging interface on the user's computing device. The gift processing system may then perform the various tasks described herein, based upon the chat-based (e.g., SMS, iMessage®) instructions received from the user's computing device.

In the examples used herein for purposes of illustration, a sender user may provide a recipient user with a gift, which may include a message and a payment. Accordingly, each component of the system and the steps of the method may involve the transfer of the gift, and are labeled using gifting terminology. However, it is intended that the present disclosure is not limited to gifts, and may be used for messaging without a gift and non-gift payments.

As payments and transactions are described herein, the values and the currencies associated with the transactions are not limited to a certain form or a type of currency. The type of currency may be ordinary form of cash currency (e.g., dollars, euros, pounds) or digital currency (e.g., crypto currency, Bitcoin, Ripple). The type of currency transmitted on a sending-side of a transaction (e.g., euros) may be different from the type of currency received on the recipient-side of the transaction (e.g., pounds). The payment-processing servers of the payment-processing system may be configured to convert the transaction value according to the respective transaction currency types or forms, according to a conversion factor, which the server of the payment-processing system may receive from external data sources or may be programmed by an administrative user. Similarly, the payment-processing server may have installed and execute a software application, which is required to conduct transactions using a digital currency, such as executable routines that update a block chain ledger to indicate an exchange in ownership over the converted digital currency value.

When the user having an account associated with a gift transfer application uses a computing device to execute the gift transfer application to conduct a transaction with the account, the user may be required to enter login details to access the gift transfer application on the computing device. Upon the entry of the login details, a processing system that runs (e.g., executes and controls the functional behavior of) the gift transfer application may execute a layer of security protocols to verify an identity of the user. For instance, upon entry of the login information in the gift transfer application, the user may receive a code on a personal mobile device and/or e-mail account of the user. The user enters the code into a user interface of the gift transfer application to verify that the account being accessed by the user belongs to the user. When the code entered by the user is correct, the processing system allows the user to access the gift transfer application.

The user may use the gift transfer application to generate a request for transmission of a gift message to a recipient user. The gift message may include a gift payment and information associated with one or more tasks. The gift transfer application on the user computing device may then generate a unique transaction token associated with the gift payment for the recipient user, and then transmit the unique transaction token to a payment-processing server and a recipient computing device of the recipient user. At the same time, the gift transfer application on the user computing device may transmit the information associated with the tasks to the recipient computing device. When the recipient user executes the tasks associated with the gift payment, then a gift application on the recipient computing device transmits the unique transaction token to the payment-processing server. The payment-processing server then matches the unique transaction token received from the recipient computing device with a stored unique transaction token for the recipient user received from the user computing device, and when the tokens are same, the payment-processing server transfer the gift payment into an account of the recipient user.

The gift transfer application on a user computing device may verify a payment destination account of the recipient user for an outgoing gift payment request initiated at the user computing device for the recipient user. In this example, the user is running the gift transfer application on the user computing device and requests the outgoing gift payment (payment of funds from user's account) for the recipient user using the gift transfer application. The gift transfer application of the user computing device then generates a unique transaction token corresponding to the gift payment. The user computing device transmits the unique transaction token to a payment-processing server of a payment-processing system. Upon the receipt of the unique transaction token from the user computing device, the payment-processing server may store the unique transaction token in a database of the payment-processing system.

When the user generates the request for the outgoing gift payment from the user computing device, the user computing device may transmit a message, which may be accessed by a web link to the recipient computing device. The message may contain a gift amount, tasks that have to be completed to receive the gift payment, and a corresponding unique transaction token. Upon receiving the message from the user computing device, the gift transfer application on the recipient computing device tracks the execution of the tasks by the recipient user. Upon the execution of the tasks by the recipient user, the gift transfer application transmits the unique transaction token to the payment-processing server. The payment-processing server then matches the unique transaction token received from the recipient computing device with a stored unique transaction token for the recipient user received from the user computing device. Upon determining that the unique transaction token received from both the user computing device and the recipient user computing device are same, the payment-processing server may then approve and initiate transfer of the gift payment. The gift transfer payment may be transferred to an account of the recipient user. In some embodiments, upon the receipt of the unique transaction token from the user computing device, the payment-processing server may withdraw the funds associated with the gift payment from an account of the sender user, and transfer the withdrawn funds to the account of the recipient user upon receiving the unique transaction token from the recipient user device and upon determining that the unique transaction token received from both the user device and the recipient user device have the same value.

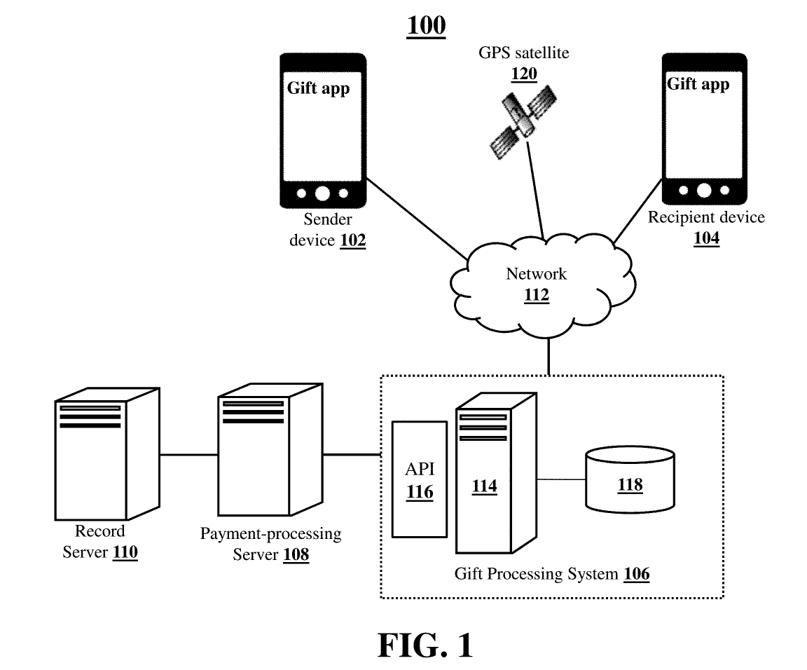

FIG. 1 is an example of a system 100 for processing payments. The system 100 may include a first computing device 102 (for example, a sender device), a second computing device 104 (for example, a recipient device), a gift processing system (GPS system) 106, a payment-processing server 108 (of a payment-processing system (PPS)), a record server 110, and a network 112. The GPS system 106 may include a GPS server 114, an Application Programming Interface (API 116), and a GPS database 118.

The system 100 may use multiple devices such as the first computing device 102 and the second computing device 104 to request that a gift payment between the devices is transferred via banking, ATM, or credit card networks. The system 100 may include one sender device such as the first computing device 102 connected to the network 112, where the sender device is capable of executing a gift transfer application of the GPS system 106. A user may use the first computing device 102 to send the payment through the GPS system 106 associated with the payment-processing server 108 to a recipient account.

The first computing device 102, the second computing device 104, the GPS system 106, the payment-processing server 108, and the record server 110 are connected to each other and communicate via the network 112. The network 112 may be a medium that also connects the GPS database 118, the payment-processing server 108, and the record server 110 of the system 100. The examples of the network 112 may include, but are not limited to, private or public LAN, WLAN, MAN, WAN, and Internet. The network 112 may include both wired and wireless communications according to one or more standards and/or via one or more transport mediums. The communication over the network 112 may be performed in accordance with various communication protocols such as Transmission Control Protocol and Internet Protocol (TCP/IP), User Datagram Protocol (UDP), and IEEE communication protocols. In one example, the network 112 may include wireless communications according to Bluetooth specification sets, or another standard or proprietary wireless communication protocol. The network 112 may also include communications over a cellular network, including, e.g. a GSM (Global System for Mobile Communications), CDMA (Code Division Multiple Access), or EDGE (Enhanced Data for Global Evolution) network.

A first computing device 102 and a second computing device 104 may be any portable or non-portable computing device with a processor/microcontroller and/or any other electronic component that performs one or more operations according to one or more programming instructions. The examples of the first computing device 102 and the second computing device 104 may include, but are not limited to, a cellular phone, a tablet computer, a smart watch, a personal data assistant, a gaming console, a laptop, or a personal computer. The first computing device 102 and the second computing device 104 are capable of communicating with the GPS system 106 and the PPS system through the network 112 using wired or wireless communication capabilities.

The first computing device 102 and the second computing device 104 may include input and output devices, to allow user interaction with programs configured to communicate with the GPS system 106 and the PPS system, to perform gift payment transactions through the GPS server 114 and the payment-processing server 108. The user may have a gift transfer application installed on the first computing device 102 from which the user access and interact with the GPS system 106 to perform the gift payment transactions. The gift transfer application may be a software stack running on an operating system of the first computing device 102 and the second computing device 104. The gift transfer application may have a protocol layer and a user interface layer where each layer may be responsible for specific functions. The protocol layer of the gift transfer application of the GPS system 106 may communicate with the operating system of the first computing device 102 and the second computing device 104, and manages the connections of the first computing device 102 and the second computing device 104 over the communication network 112. The protocol layer may communicate with the user interface layer. The protocol layer may be arranged to control the user interface layer to present information to the user via the user interface of the gift transfer application on the first computing device 102 and the second computing device 104, and to receive information from the user via the user interface of the gift transfer application on the first computing device 102 and the second computing device 104.

A user may have a payment-processing application of a PPS system installed on the first computing device 102 and the second computing device 104 from which the user can access and interact with a payment-processing server 108 of the PPS system to perform financial transactions. The user may access features of the payment-processing application via the gift transfer application, and interact with the payment-processing server 108 via the GPS system 106 to perform the financial transactions. The payment-processing application may be a software stack running on an operating system of the first computing device 102 and the second computing device 104. The payment transfer application may have a protocol layer and a user interface layer where each layer may be responsible for specific functions. The protocol layer may communicate with the operating system of the first computing device 102 and the second computing device 104, and manages the connections of the first computing device 102 and the second computing device 104 over the communication network 112. The protocol layer may also communicate with the user interface layer. The protocol layer may be arranged to control the user interface layer to present information to the user via the user interface of the gift transfer application on the first computing device 102 and the second computing device 104, and to receive information from the user via the user interface of the gift transfer application on the first computing device 102. The protocol layer may also communicate with the user interface layer and may be arranged to control the user interface layer to present information to the user via the user interface of the payment transfer application on the first computing device 102 and the second computing device 104, and to receive information from the user via the user interface of the payment transfer application on the first computing device 102.

The first computing device 102 may run a web browser that accesses and presents a gift transfer web application to be executed by a processor of at least one of the first computing device 102, the second computing device 104, or the GPS server 114, and allows the user to perform the gift payment transactions using the gift transfer web application on the first computing device 102 and the second computing device 104. The first computing device 102 and the second computing device 104 may execute a gift transfer/processing application outside of a web browser, for example, an operating system-specific gift transfer application that accesses and presents information processed by the processor of the first computing device 102, the second computing device 104, and the GPS server 114 to perform the gift payment transactions.

The first computing device 102 and the second computing device 104 may store data related to transactions performed by the user using the gift transfer application. The transaction data may be stored in a local database associated with the first computing device 102 and the second computing device 104. The data such as a list of recipients, a list of images, a list of videos, and/or other transaction data transmitted over the network 112 from the first computing device 102 and the second computing device 104 to the local database may be formatted in accordance with a variety of different protocols such as security and communication protocols. For example, all or a portion of the communication network 112 may be a packet-based, Internet Protocol network that communicates the data from the first computing device 102 and the second computing device 104 to the local database in Transmission Control Protocol/Internet Protocol packets. In one example, the gift payments processed on the first computing device 102 and the second computing device 104 using the gift transfer application or the payment transfer application may be formatted, as transaction data, in accordance with a formatting specification or protocol expected by the local database or the GPS system 106, and then the formatted data may be transmitted by the first computing device 102 and the second computing device 104 to the local database.

A local database associated with the first computing device 102, the second computing device 104, and the GPS server 114 may be in communication to each other via the network 112 and include a non-transitory machine-readable storage media capable of receiving and storing transaction records. The local database may have a logical construct of data files, that are stored in non-transitory machine-readable storage media, such as a hard disk or memory, controlled by software modules of a database program (for example, SQL), and a related database management system (DBMS) that executes the code modules (for example, SQL scripts) for various data queries and management functions generated by the first computing device 102, the second computing device 104, and the GPS server 114.

A memory of the local database associated with the first computing device 102, the second computing device 104, and the GPS server 114 may be a non-volatile storage device for storing data and instructions to be used by a processor of the first computing device 102, the second computing device 104, or the GPS server 114. The memory may be implemented with a magnetic disk drive, an optical disk drive, a solid-state device, or an attachment to network storage. The memory may include one or more memory devices to facilitate storage and manipulation of program code, set of instructions, tasks, data, PDKs, and the like. Non-limiting examples of memory implementations may include, but are not limited to, a random access memory (RAM), a read only memory (ROM), a hard disk drive (HDD), a secure digital (SD) card, a magneto-resistive read/write memory, an optical read/write memory, a cache memory, or a magnetic read/write memory.

A memory of the local database associated with the first computing device 102, the second computing device 104, and the GPS server 114 may be a temporary memory, such that a primary purpose of the memory is not long-term storage. The memory in some examples, described as a volatile memory, meaning that the memory do not maintain stored contents when the devices are turned off. Examples of the volatile memories may include dynamic random access memories (DRAM), static random access memories (SRAM), and other forms of volatile memories known in the art. In some embodiments, the memory may be configured to store larger amounts of information than volatile memory. The memory may further be configured for long-term storage of information. In some examples, the memory may include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

A GPS system 106 may include GPS servers 114, at least some of which can handle secure gift payment transactions to process all gift payment transactions between a sender and a recipient mobile or electronic devices (such as the first computing device 102 and the second computing device 104). The GPS server 114 is a portable or non-portable computing server device with a processor/microcontroller that performs operations according to programming instructions. The examples of the GPS server 114 may include, but are not limited to, a cellular phone, a tablet computer, a smart watch, a personal data assistant, a gaming console, a laptop, or a personal computer. The GPS server 114 is capable of communicating with the PPS system through the network 112 using the wired or wireless communication capabilities.

A processor may operate the GPS system 106. A single processor or a plurality of processors may be employed for configuring the payment-processing system as a multi-processor system. The processor may include suitable logic, circuitry, and interfaces that are operable to execute one or more instructions to perform data transfer and operations. The processor may be realized through a number of processor technologies. The examples of the processor include, but are not limited to, an x86 processor, an ARM processor, a Reduced Instruction Set Computing (RISC) processor, an Application-Specific Integrated Circuit (ASIC) processor, or a Complex Instruction Set Computing (CISC) processor. The processor may also include a Graphics Processing Unit (GPU) that executes the instructions to perform processing operations.

The processor processes the gift payment transfers conducted between the sender and recipient electronic computing devices (such as the first computing device 102 and the second computing device 104). The sender device (for instance, the first computing device 102) can initiate a request for the gift payment transfer to the recipient device (for instance, the second computing device 104) through the GPS server 114 via the gift processing application. The GPS server 114 based on the request may generate instructions to transfer the gift payment from a sender card account to a recipient card account, and can communicate with the sender and recipient mobile or electronic devices (such as the first computing device 102 and the second computing device 104).

One or more accounts (e.g., debit or credit card accounts) can be associated with a payment-processing application linked to a gift transfer application installed on the first computing device 102 and the second computing device 104. An account can be a financial account managed by a card issuer, and can be associated with a card number. The accounts may be stored at a payment-processing server 108 or a GPS server 114. The payment-processing server 108 may communicate with a record server 110 of a debit card payment network. The payment-processing server 108 may communicate with the record server 110 of a credit card payment network, e.g., over the network 112. In some embodiments, to transfer the gift payment between the sender and the recipient, the payment-processing server 108 may identify debit card accounts, e.g., stored at a transaction database, for the sender.

The payment-processing server 108 may submit a request to an appropriate card issuer, e.g., the sender's card issuer, to transfer the gift payment. The appropriate card issuer may receive and process the request by transferring the gift payment to the appropriate card account. To transfer the gift payment between the sender and the recipient, the payment-processing server 108 may receive a payment amount by processing a card, e.g., a credit card or a debit card, of the sender and hold the payment amount. The payment-processing server 108 may then push the payment amount of the gift payment to a debit account of the recipient upon receiving a notification regarding execution of one or more tasks (such as challenge events) by the recipient. Instead of holding the payment amount, the payment-processing server 108 may also forward the payment amount once the recipient links an account with the payment-processing server 108.

The GPS server 114 and the payment-processing server 108 may operate between the first computing device 102, the second computing device 104, and the record server 110. The GPS server 114 is part of the GPS system 106, which may also include the API 116 and the GPS database 118. The GPS server 114 may use the API 116 to communicate with the first and the second computing devices 102, 104 belonging to the sender user or the recipient user over the network 112. The GPS database 118 may include information such a user profile, recipient lists, and transaction accounts of the sender user and the recipient user. In the system 100 seen in FIG. 1, the GPS server 114 may receive transmissions regarding the gift payment requests that occur between a device of the sender user, the payment-processing server 108, and the record server 110. Upon receiving the gift payment request from the sender user and generating a payload, the GPS server 114 may forward the transaction to the payment-processing server 108. The payment-processing server 108 may further forward the transaction to the record server 110 that is associated with a financial institute. The GPS server 114 may also directly contact the financial institute in order to facilitate the gift payment request and transaction upon receiving a notification about execution of the tasks associated with the payment request from a device of the recipient.

A record server 110 is hosted by a financial institute or a third party that may provide a service to a financial institution. The record server 110 may include processors to execute tasks. The record server 110 may employ a single processor. The record server 110 may employ multiple processors to maintain information regarding a balance of an account maintained by the user at the financial institute.

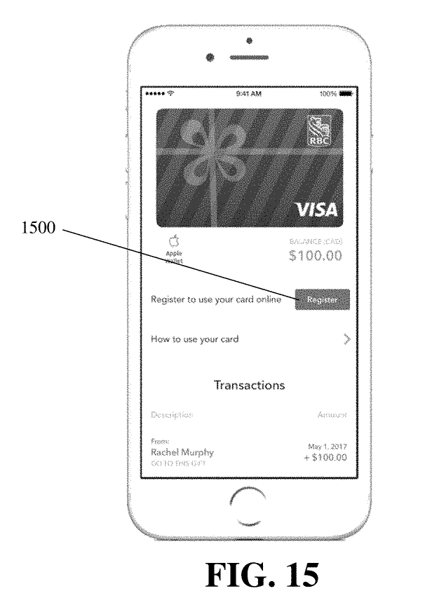

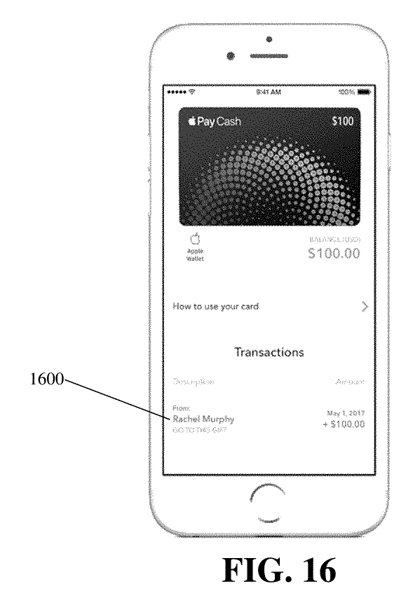

In operation, as depicted in FIGS. 15-16, a user (for example, a sender user) of the first computing device 102 may initially be required to register with a financial institution using a register button 1500, and information regarding a balance of their account may be displayed on the first computing device 102. Any gift payments received in the account of the user of the first computing device 102 may then be displayed along with a name of the sender user 1600 on a graphical user interface (GUI) of the first computing device 102.

When a gift message generated by the sender user for the recipient user includes a digital or virtual gift card, the recipient user may be required to register their information before the recipient user can receive the gift. For example, when the recipient user receives the gift message and complies with the task challenge (if any), the gift transfer application may then display a prompt that requires the recipient to register for the digital gift card (as shown in FIG. 15). Upon the recipient user completing the registration process, the gift transfer application may then display information regarding the digital card (e.g., the sender, amount, and the like), as illustrated in FIG. 16. The virtual card may then be added to an electronic wallet of the recipient user. Certain parties, such as the user who is an account owner or an administrator of the GPS system 106 and the payment-processing system may assume certain risks that an account holder does not have sufficient funds to fund a transaction, until the record server 110 authorizes the transaction. Upon receiving a payment request, the payment-processing server 108 may forward associated information to the record server 110, which maintains an account corresponding to the balance of the user. The financial institute may also generate an authorization response to forward to the record server 110, back through other devices in a payment stream and eventually to the payment-processing server 108 and/or the GPS server 114 to confirm that the sender user or the recipient user may complete the payment transaction. The payment-processing server 108 and/or the GPS server 114 may either receive authorization from the financial institute, or create a custom authorization or anti-fraud procedure in order to authorize the gift payment requests.

During operation, a sender user may access a gift transfer application of a GPS system 106 installed on a first computing device 102. Initially, the sender user may not have an account on the gift transfer application, and the sender user may register on the gift transfer application. The sender user may register on the gift transfer application using a full name, a phone number, a bank account number, a payment-processing account, and/or e-mail address to access the features of the gift transfer application.

Upon registration on the gift transfer application, the sender user may access features of the gift transfer application and information within the first computing device 102. The first computing device 102 may contain a list of recipient users. The list of recipient users may include a name of each recipient user, a phone number of each recipient user, a username associated to a gift transfer application of the recipient user, e-mail address of each recipient user, and bank account details for each recipient user. The list of recipient users and their corresponding details may be stored on a local database associated with the first computing device 102 or a GPS database 118.

The sender user may enter the login information to access the gift transfer application account on the first computing device 102. Then the GPS server 114 associated with the gift transfer application may receive the login data entered by the user, and the GPS server 114 may implement a series of security protocols in order to verify that a service account of the gift transfer application being accessed by the user on the first computing device 102 belongs to the user. For instance, in one of the security protocol implemented by the GPS server 114, the GPS server 114 may generate a security code that may be transmitted to a phone number of the sender user. The GPS server 114 may request the sender user to enter the code on a user interface of the gift transfer application. In one example, the code may include a secret token, which may be for example a globally unique identifier (GUID), such as for example but not limited to a unique string of characters including, but not limited to letters or numbers or both. In another example, the code may also include one or more Uniform Resource Locators (URLs). The URL may be used to designate an address from which the first computing device 102 may obtain instructions and/or information for logging into their service account. The code may be associated with an expiry time. The expiry time may be included in the code. The expiry time may be recorded together with the secret token associated with the code at the GPS database 118 associated with the GPS server 114 when the code is generated.

Using the gift transfer application, the sender user may generate a gift message. The gift message may include a gift payment and tasks for a recipient user. The sender user may select a payment amount for the gift payment and particulars of the tasks to be completed by the recipient user in order to obtain the gift payment. The sender user via the gift transfer application on the first computing device 102 may transmit the gift message to the recipient user on the second computing device 104. A gift transfer application on the second computing device 104 may receive the gift message. The gift message may include information associated with each task to be completed by the recipient user to receive the gift payment.

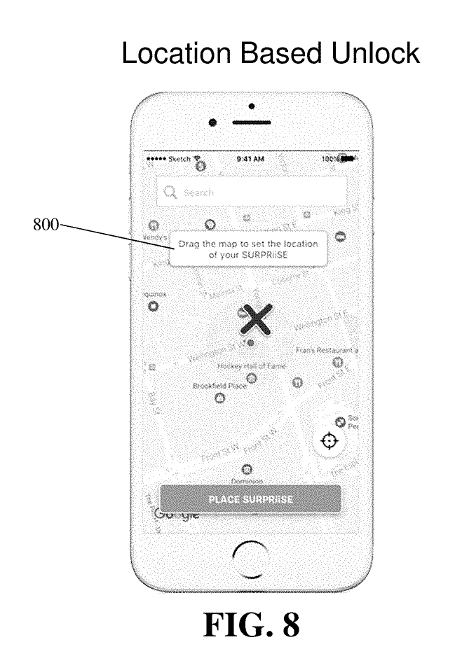

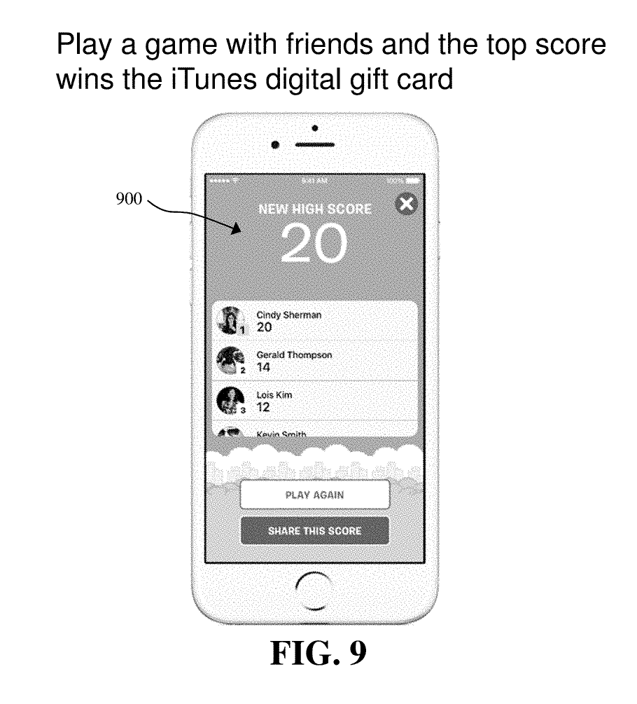

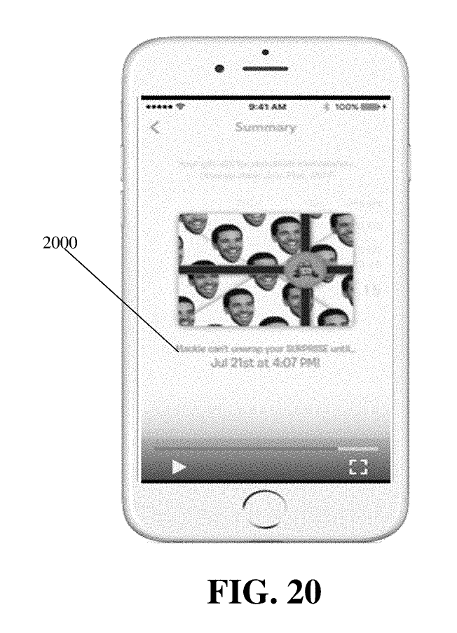

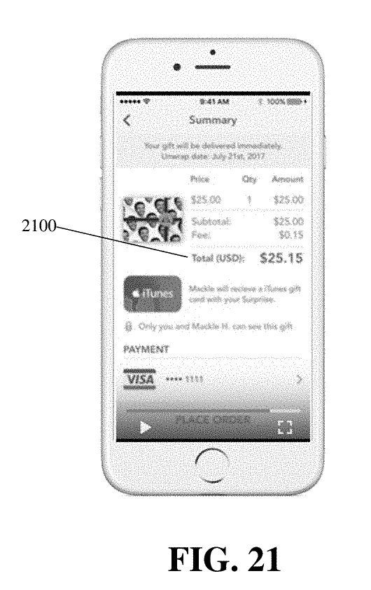

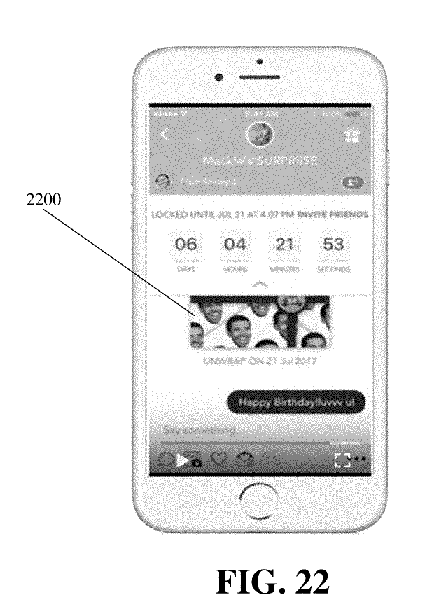

A first non-limiting example of a task may be a request for the recipient user to visit to a specific location in order to obtain the gift payment in the gift message. As depicted in FIG. 8, a task 800 may be generated on the gift transfer application, which may require the recipient user to visit the particular location to be able to access information associated with the gift payment. When the recipient user visits the particular location, the gift transfer application on the second computing device 104 may track the location of the recipient user, and accordingly allow the recipient user to access the information associated with the gift payment. The recipient user may then be able to access the information associated with the gift payment. A second non-limiting example of the task may be a request for the recipient user to play a specific game and get a specific score in order to obtain the gift payment in the gift message. As depicted in FIG. 9, a task 900 displayed on the gift transfer application may require the recipient user to play a game and then share a score of the game. The recipient user may receive the gift payment as iTunes gift card on the second computing device 104 upon receiving a top score in the game. A third non-limiting example of the task may be a request for the recipient user to wait until a pre-defined date and time in order to obtain the gift payment in the gift message. As depicted in FIG. 20, a task 2000 displayed on the gift transfer application may require the recipient user to wait until a pre-defined date (July 21) and time (04:07 PM) in order to obtain the gift payment in the gift message. The recipient user may receive the gift payment on the second computing device 104 on the pre-defined date and time, and total balance amount icon 2100 may be updated, as depicted in FIG. 21. A fourth non-limiting example of the task may be a request for the recipient user to wait until a pre-defined date and time, and then play a specific game and get a specific score in order to obtain the gift payment in the gift message. A fifth non-limiting example of the task may be a request for the recipient user to wait until a pre-defined date and time, and then visit a specific location in order to obtain the gift payment in the gift message. A sixth non-limiting example of the task may be a request for the recipient user to wait until their birthday in order to obtain the gift payment in the gift message. As depicted in the FIG. 22, an unwrap task 2200 displayed on the gift transfer application may require the recipient user to wait until a date of a birthday to obtain the gift payment in the gift message. The recipient user may then receive the gift payment on the second computing device 104 on their birthday.

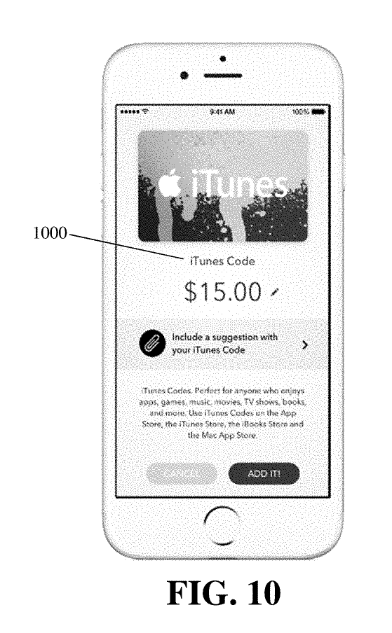

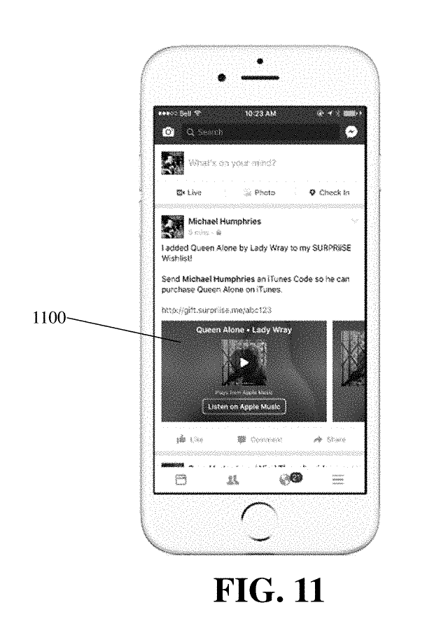

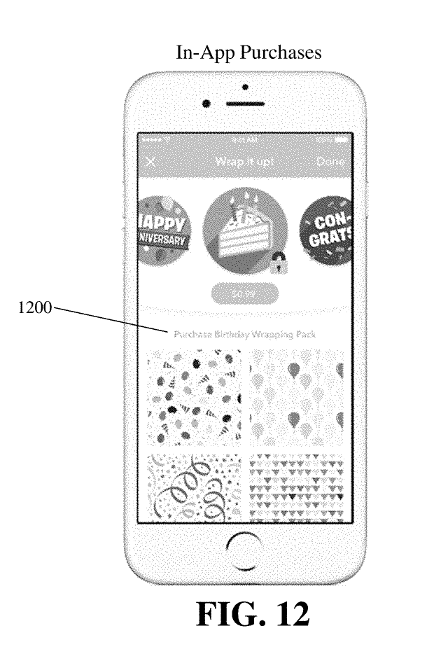

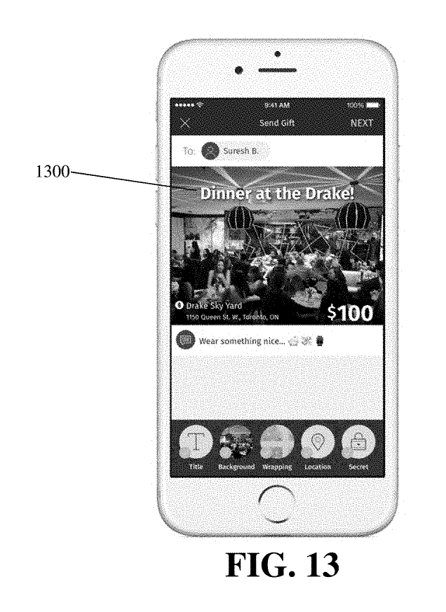

In one example, upon logging into the gift transfer application on the first computing device 102, the sender user may generate a gift message comprising at least a gift payment and one or more items (e.g., iTunes code package 1000 as depicted in FIG. 10, a song 1100 as depicted in FIG. 11, a digital wrapping pack 1200 as depicted in FIG. 12, a digital coupon or a suggestion for use 1300 for a hotel as depicted in FIG. 13) using the gift transfer application for a recipient user. The digital coupon may be selected by the sender user. In some configurations, the gift message may include a pre-paid virtual gift card associated with an institution (e.g., virtual card of a restaurant or a hotel), which may be activated based on a location associated with a mobile device of the recipient user. The sender user may select a gift payment amount for the recipient user to be included in the gift message. The sender user may also select the items such as an image, a video file, a game, a file document, or any other suitable information from a local database of the first computing device 102 or any other external database to be included in the gift message. The item can also be a product or service offered by one or more retailers. Examples of the items may include a virtual item, such as an electronic movie ticket, digital song or gaming content. In some cases, the examples of the items may include real gifts coupons associated with, but not limited to, a tangible item, such as books, food items, consumer products, and other physical good; and a service coupon such as a spa treatment. Other examples of the items may be associated with an intangible item, such as monetary credit and gift points redeemable at a particular retailer or group of retailers. The retailer may have a physical retail store that can be visited by the intended recipient to obtain the gift. The retailer can be an online retailer operating a web site on the Internet, which functions as a virtual store from which the intended gift recipient user can order the gift items.

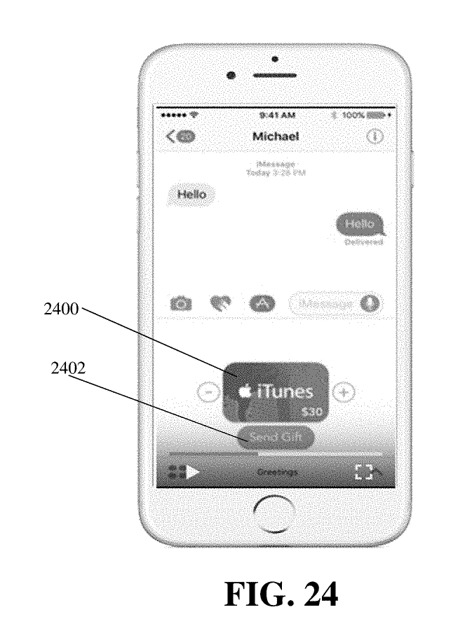

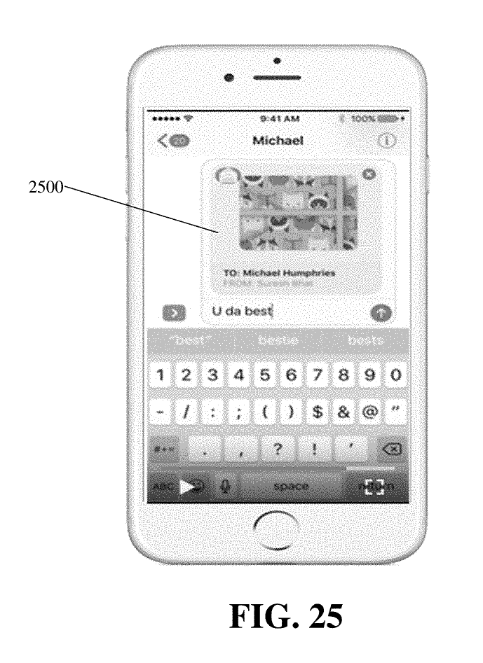

The first computing device 102 may arrange the gift payment and the items within the gift message in a pre-defined order for display on the second computing device 104 of the recipient user. The first computing device 102 may electronically transmit the gift message and various tasks to the second computing device 104. The gift message and the various tasks are displayed on a GUI of the second computing device 104 in the pre-defined order. For example, the first computing device 102 may electronically transmit the gift message including a gift card 2400 to the second computing device 104 in a text message, as depicted in FIG. 24, which illustrates a user interface displayed on the first computing device 102. In another example, the first computing device 102 may electronically transmit a gift card 2500 to the second computing device 104 in a text message, as depicted in FIG. 25, which also depicts a user interface displayed on the first computing device 102.

FIG. 24 and FIG. 25 also illustrates that the gift transfer application may be embedded and executed while the sender user is operating a messaging application on the first computing device 102. For example, the sender user may activate the gift transfer application by engaging an icon (such as the icon 2404) while operating a messaging application. The gift transfer application may then display a graphical component embedded within the messaging application (e.g., gift card 2400), and allow the sender user to generate and transmit a gift message to a recipient user without having to switch between the messaging application and the gift transfer application (e.g., by using icon 2402 and sending the gift message as illustrated in FIG. 25).

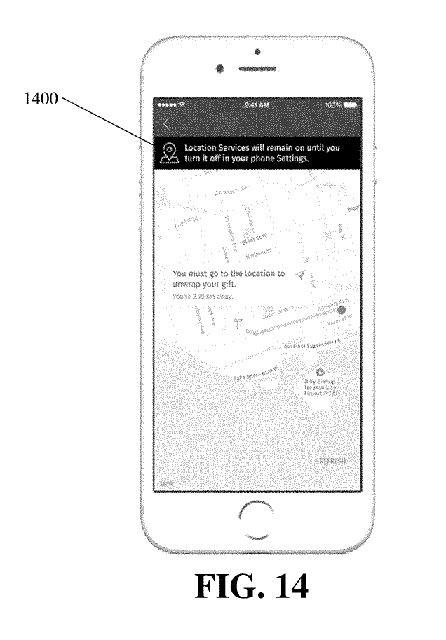

Referring back to FIG. 1, the first computing device 102 may transmit the gift message and the tasks to the second computing device 104 to be displayed on a gift transfer application installed on the second computing device 104 in the pre-defined order. The gift message may be displayed on a GUI of the second computing device 104 in the pre-defined order upon triggering of a condition. For instance, the recipient user of the second computing device 104 may have to execute tasks in order to access contents of the gift message such as the gift payment and the items. The tasks may include a first set of tasks and a second set of tasks. Upon completion of the first set of tasks, the recipient user of the second computing device 104 may obtain the gift payment within the gift message. Upon completion of the second set of tasks, the recipient user of the second computing device 104 may obtain the one or more items within the gift message. Each task may have a separate set of instructions and timelines for execution by the recipient user. In one example, the task may be a request for the recipient user to go to a specific location in order to access the contents of the gift message. In such a case, the first computing device 102 may track a current location of the second computing device 104 using a Global Positioning System satellite system 120. The Global Positioning System satellite system 120 is a network of plurality of satellites that is used to determine a location of an antenna of the second computing device 104 that receives signals from a number of satellites of the Global Positioning System satellite system 120. In some instances, the second computing device 104 may itself track its current location using a location services application 1400, as depicted in the FIG. 14.

During the generation of the gift message, a gift transfer application on the first computing device 102 may also generate a unique transaction token associated with the gift message for a recipient user of the second computing device 104. The gift transfer application on the first computing device 102 may transmit the unique transaction token to a payment-processing server 108 and the second computing device 104 along with the gift message or within the gift message. When the recipient user executes various tasks associated with the gift message, then the gift transfer application on the second computing device 104 transmits the unique transaction token to the payment-processing server 108. The gift transfer application on the second computing device 104 tracks activities of the recipient user and determine whether the tasks have been executed or not. The first computing device 102 may also track the activity of the recipient user and location of the second computing device 104 using the Global Positioning System satellite system 120, and accordingly determine whether the tasks have been executed or not by the recipient user. When the gift transfer application on the second computing device 104 or the first computing device 102 determines that the recipient user have executed the tasks, then the gift transfer application on the second computing device 104 transmits the unique transaction token to the payment-processing server 108.

Upon receipt of the unique transaction token from the gift transfer application on second computing device 104, the payment-processing server 108 may match the unique transaction token received from the second computing device 104 with a stored value of the unique transaction token for the recipient user received from the first computing device 102. The payment-processing server 108, upon determining that the unique transaction token received from both the first computing device 102 and the second computing device 104 matches, may then approve transfer of the gift payment amount associated with the unique transaction token and initiate a transfer of the gift payment amount to a bank account of the recipient user. When the gift payment amount is transferred to the account of the recipient user, a notification may be displayed regarding the deposit of the gift payment amount on the GUI of the second computing device 104 or on the gift transfer application of the second computing device 104.

The GPS system 106 may instruct the payment-processing server 108 to withdraw funds (e.g., a gift payment amount associated with the gift payment) from a financial account of the sender user, hold the funds in an escrow account, and release the funds to the recipient user upon validating the transaction (e.g., receiving a matching token from the second computing device 104). For example, when the sender user indicates a desire using the gift transfer application executing on the first computing device 102 to transfer the funds to the recipient user, the payment-processing server 108 may withdraw the funds from the financial account of the sender user, and hold the funds within a third account, such as an escrow account. When the payment-processing server 108 receives a matching token (as described above), the payment-processing server 108 may then release the funds by transferring the funds from the escrow account to an account of the recipient user.

Upon the comparison of the unique transaction tokens, the payment-processing server 108 may transmit a message to the GPS server 114 regarding receipt of the correct unique transaction token from the second computing device 104. The GPS server 114 and/or the payment-processing server 108 may then generate additional security layer of questions for the recipient user, and transmit the additional questions to the second computing device 104. A list of questions for the recipient user may include, but not limited to, information related to a bank account, a social security number, mother's name, father's name, date of birth, year of opening the account, or last three transactions performed by the recipient user. The GPS server 114 and/or the payment-processing server 108 may then transmit the list of questions to the second computing device 104.

The second computing device 104 may transmit answers to the questions provided by the recipient user to the GPS server 114. After receiving the answers, the GPS server 114 may match the received answers with stored answers to a same set of questions previously provided by the recipient user, at the time of initial registration of service account of a payment transfer application associated with a gift transfer application. The stored answers are within the GPS database 118. The GPS server 114 upon determining that the received answers are correct may authorize the payment-processing server 108 to transfer the gift payment to an account of the recipient user.

The GPS server 114 may generate a confirmation request, which may relate to an identity of the recipient user. The confirmation request may include information of the recipient user including, but not limited to, a name of the recipient user, a picture of the recipient user, and/or bank account information of the recipient user. The GPS server 114 and/or the payment-processing server 108 may obtain the information about the recipient user, such as the picture of the recipient user, from an external database, by searching for social networking profiles of the recipient user. The GPS server 114 and/or the payment-processing server 108 may use input data provided by the sender user to find the information associated with the recipient user. The input data may include information of the recipient user provided within the gift message. The GPS server 114 may transmit the confirmation request to the first computing device 102. Upon receiving the confirmation request, the sender user of the first computing device 102 may input a response to be sent back to the GPS server 114. Upon receiving, by the GPS server 114, a positive confirmation from the sender user in response to the confirmation request, the GPS server 114 may then approve the gift payment transfer process corresponding to the gift message, and the gift payment is transferred to the account of the recipient user.

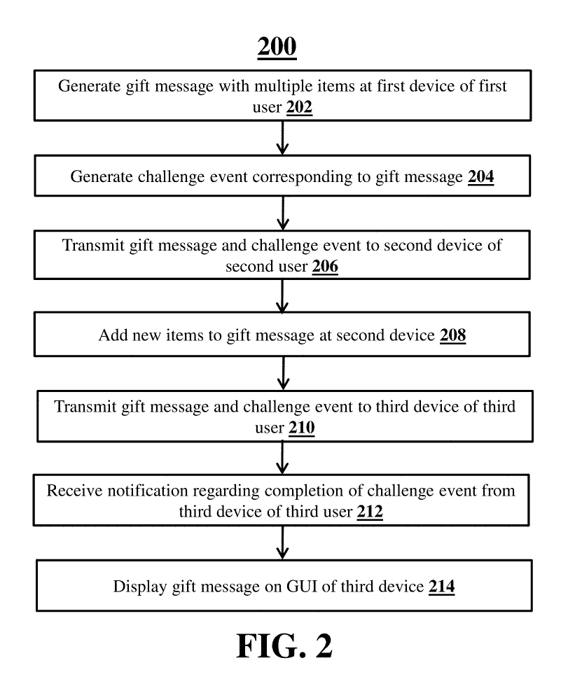

FIG. 2 shows execution steps of processing gift payments using a gift transfer application on a computing device, according to a method 200. The method 200 shown in FIG. 2 comprises execution steps 202, 204, 206, 208, 210, 212, and 214 implemented using modules of a GPS system such as a GPS server. However, it should be appreciated that other embodiments may comprise additional or alternative execution steps, or may omit one or more steps altogether. It should also be appreciated that other embodiments may perform certain execution steps in a different order; steps may also be performed simultaneously or near-simultaneously with one another. In addition, the method 200 of FIG. 2 is described as being executed by a single server, referred to as a GPS server having one or more processors and/or software modules in this embodiment. However, one having skill in the art will appreciate that, in some embodiments, steps may be executed by any number of GPS servers operating in a distributed cloud computing environment. In some cases, a GPS server executing one or more steps may be programmed to execute various other, unrelated features, where such GPS server does not need to be operating strictly as the GPS server described herein. FIG. 2 does not imply any limitations with regard to the environments or embodiments that may be implemented. Modifications to the depicted environment or embodiment shown in FIG. 2 may be made.

At step 202, a first device (such as a first computer or a first mobile phone) being operated by a first user may generate a gift message (such as a digital envelope) using a gift transfer application and/or an electronic message application being accessed from the first device. The gift message is generated for a third user operating a third device. The gift transfer application may be installed on the first device. The gift transfer application may be accessed via a web browser on the first device. The gift transfer application may be embedded into a third-party application. For example, the gift transfer application may be accessed via a third-party payment application (e.g., RBC digital wallet) on the first device. The gift transfer application may be invoked upon receiving an indication from the first device executing the third-party payment application. The first device may select a gift payment amount, a payment account of the third user, media elements, and various items from a local database of the first device to include in the gift message. The first device may arrange the media elements, the items and the gift payment amount note in a pre-defined order such that when the gift message is displayed on third device, the various items are shown in the pre-defined order.

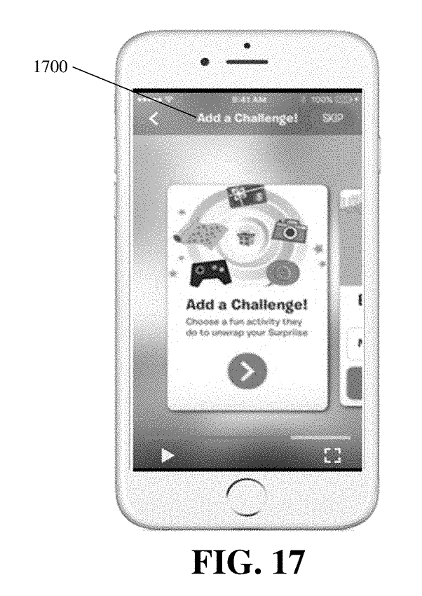

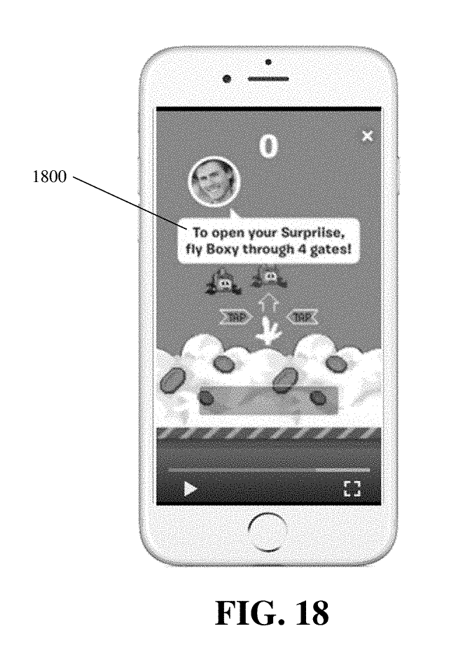

At step 204, a first device may generate a gift payment criterion. The gift payment criterion may include one or more challenge events (such as tasks) associated with the gift message using a challenge icon 1700 as depicted in FIG. 17. The first device may further generate a set of instructions corresponding to each challenge event. The set of instructions provide information associated with a challenge task of the challenge event, how to perform the challenge task, when to perform the challenge task, where to perform the challenge task, how to notify upon completion of the challenge task, and who to notify upon the completion of the challenge task. In some embodiments, a unique challenge event may be generated for each item within the gift message. In some embodiments, a challenge event may be generated for a group of items within the gift message. In one example, as depicted in the FIG. 18, the first device may generate a challenge event according to which the third user may only be able to access contents within the gift message upon playing a certain game 1800 and getting a certain score as defined in the instructions for playing the game.

A GPS system may provide the first user with a set of software development kit (SDK) to generate challenges or payment triggers. The SDK is a set of software development tools that allows the creation of applications (e.g., different challenges and payment triggers) within the framework provided by the gift transfer application executing on the first device of the first user. The SDK may be a platform-specific application and may be different for each first device of each first user. For example, the development of an Android app on Java platform requires a Java Development Kit, for iOS apps the iOS SDK, and for Universal Windows Platform the .NET Framework SDK. Therefore, the GPS server may determine a platform used by each first user, and provide appropriate the SDK in order to allow the first user to generate and populate their own challenges. For example, the first user may use the gift transfer application to design a challenge (e.g., game, puzzle, riddle, or any other payment trigger).

The SDK may be a third party, which is invoked (activated) upon receiving a request of the first user. For instance, when the GPS system receives and indication that the first user is interested in creating a challenge, the GPS server may execute a third-party SDK application allowing the first user to generate a customized challenge or payment triggers.

The GPS system may also provide a content management service to the first user by allowing the first user to upload and/or download customize software code representing different challenges, payment triggers, or multimedia elements. In a non-limiting example, the GPS system may allow different sender users to upload different challenges (e.g., games, multimedia elements, sounds, images, and the like) from third party vendors/game providers and include the uploaded challenge into a gift message. The GPS system may store the uploaded challenge into a local or remote server. The GPS system may also allow various sender users to download and append all the challenges uploaded. For example, the first user may view all uploaded challenges (by other sender users) in a library of challenges, and may select a challenge to be appended to the gift payment.

At step 206, a first device transmits the gift message and the challenge events associated with the gift message via a gift transfer application to a second device of a second user. In some embodiments, the first device transmits the gift message and one or more challenge events (tasks) associated with the gift message via the gift transfer application to a gift transfer application installed on the second device of the second user.

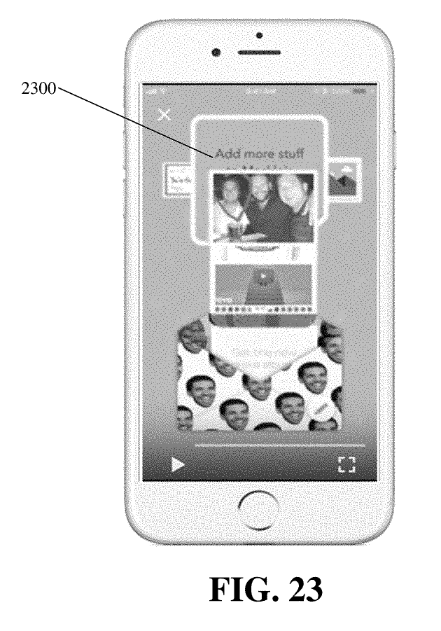

At step 208, a second device may add new gift payment amounts, new items, and media elements into the gift message. For example, as depicted in FIG. 23, the new gift payment amounts, the new items, and the media elements may be added using an addition button 2300 displayed on a GUI of the second device. The second device may select the new items and the media elements from a local database of the second device, and then add the new items and the media elements to the gift message. The second device may re-order the arrangement of the items and the new items to be displayed on the third device. The second device may generate a new payment criterion, which is a new challenge event corresponding to the new gift payment amounts and the new items of an updated gift message. The second device may further generate a set of instructions corresponding to each new challenge event. The set of instructions may provide information associated with a challenge task of the new challenge event, how to perform the new challenge task, when to perform the new challenge task, where to perform the new challenge task, how to notify upon completion of the new challenge task, and who to notify upon the completion of the new challenge task.

The first device may indicate an “open date” associated with the gift message that indicates a deadline for other sender users such as the second user to add gift elements to a gift message. For example, the first user upon generating the gift message may indicate a deadline for the second user to add or modify the gift message. The second user may only add a new gift element (e.g., amount, multimedia elements, items, and the like) within the time period allotted by the first user. The “open date” may be a strict deadline (e.g., a time-period in which the second user may add new gift items). For example, the second user may not be able to add the new gift element after the open date deadline has expired. The “open date” may be set as an open deadline; for example, the second user may be able to add the new gift element until the third user has activated the gift message.

At step 210, a second device may transmit gift message and challenge events associated with the gift message to the third device. The second device transmits the gift message and the challenge events associated with the gift message via a gift transfer application to the third device. The second device transmits the gift message and the challenge events associated with the gift message via the gift transfer application to another gift transfer application installed on the third device.

Prior to transmitting the gift message to the third device, in some implementations, the gift transfer application on the second device and/or the first device may generate a unique transaction token associated with the gift payment amount of the gift message for the third user operating the third device. The second device and/or the first device may transmit the unique transaction token to a payment-processing server as well as the third device upon the transmission of the gift message and the challenge events to the third device.

The GPS system (via controlling the functional behavior of the gift applications executing on multiple senders' computing devices) may allow multiple sender users (such as the first user and the second user) to collaboratively transfer a single gift message including a gift payment to a recipient user (such as a third user). The GPS system allows the multiple sender users to add individual gift amount, multimedia elements, items, and/or payment conditions to a single gift. The GPS system may receive gift attributes from the multiple sender users, and generate a single gift message (with a single digital envelope) to be transmitted to the recipient user. For example, a first user may generate a gift message (including a gift amount and multimedia elements), and transmit the gift message to a second user (e.g., a second device of a second user to transfer a gift or payment to the third user). Upon receiving an indication that the multiple sender users are transferring a gift to a recipient user, the GPS server may create an instance in a database (internal or external) that corresponds to the particular gift message.

Upon receiving the gift message, the second user may then add a second set of gift attributes (e.g., gift amount, multimedia elements, and/or payment conditions to the gift). The GPS server may then update the instance associated with the gift message within the database. The gift message may be shared with multiple sender users, and each sender user may add their own gift amount, multimedia elements, and/or payment conditions. The GPS server may update the instance within the database as many times as necessary in order for the instance to reflect the most current gift attributes and data. When all the sender users have completed their respective gift message generation, the GPS server may then generate a unified gift message that includes all gift attributes and data. The GPS server may then transmit the unified gift message to the third device of the third user.

At step 212, a gift transfer application of the third device may track activate of the third user at the third device. When the third user performs tasks associated with the various challenge events, then the gift transfer application or the third device may transmit the unique transaction token to a payment-processing server. The payment-processing server matches the unique transaction token received from the third device with a stored unique transaction token received from the first or the second device, in order to process the gift payment within the gift of the third user.

The first device and/or the second device may also determine whether the third user has completed the tasks associated with the various challenge events. For example, the first device and/or the second device may indicate to the third user that the third user must upload a particular video using the third device, and the gift may only be transferred upon the either the first device or the second device approving the upload of the video. The third device may upload the requested video, and the GPS server may notify the first device and/or the second device that the video has been uploaded. The GPS server may also display the video on the first device and/or the second device. The GPS server may then receive approval message regarding the video from the first device and/or the second device. The GPS server may then transfer the gift to the third device. In another example, the first device and/or the second device may request a task of the third user at the third device. The third user using the third device may update the first device and/or the second device to show the completion status of the task.

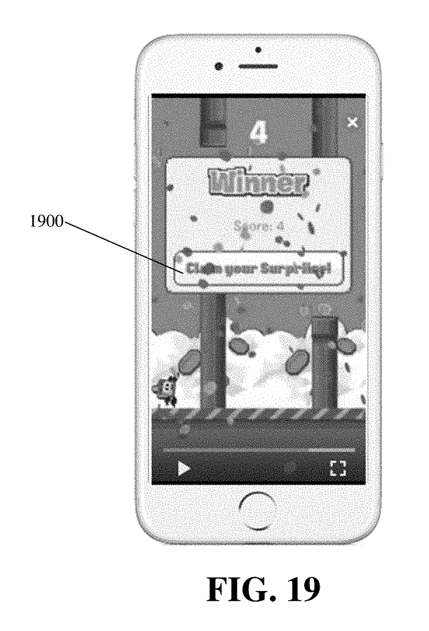

At step 214, a payment-processing server upon determining that the unique transaction token received from the first device and/or the second device, as well as the third device is same; the payment-processing server may then approve the transfer of the gift payment amount and initiate transfer of the gift payment amount. The gift payment amount is transferred to an account of the third user, and the gift message with other items in a form of digital envelope is displayed on a GUI of the third device or on the gift transfer application running on the third device, upon clicking a button 1900, as depicted in the FIG. 19.

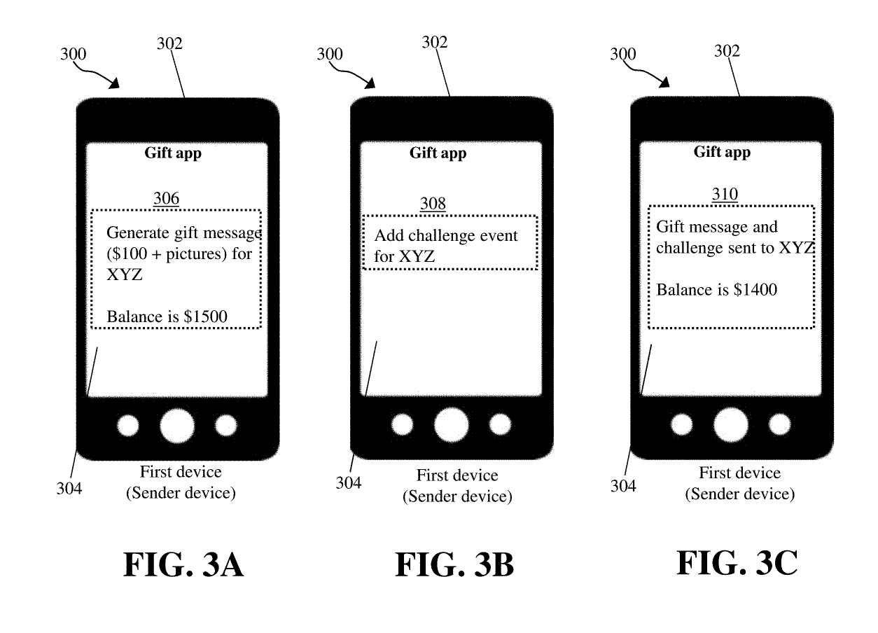

FIGS. 3A, 3B, and 3C illustrate a GUI 304 for presenting gift generation process when a user (ABC) is accessing a gift transfer application on a first computing device 300 (for example, a sender device). The first computing device 300 has a display 302. The display 302 may include a cathode ray tube (CRT) display, a liquid crystal display (LCD), a plasma, or a light emitting diode (LED) display. The display 302 may provide some or all of the functionality of the GUI 304. The display 302 may be a touch-sensitive and/or a presence-sensitive display that can display the GUI 304 and detect input from a user in the form of user input gestures. A graphics subsystem may receive textual and graphical information, and then process the information for output to the display 302.

The display 302 may include the GUI 304 that allows the user to interact with the first computing device 300. The examples of the GUI 304 may include, but are not limited to, a keypad embedded on the first computing device 300, a keyboard, a mouse, a roller ball, buttons, stylus, or devices that allow the user to interact with the first computing device 300. In some examples, the first computing device 300 does not include the GUI 304, and the user interacts with the first computing device 300 with the display 302 (e.g., by providing various user gestures). In some examples, the user interacts with the first computing device 300 with the GUI 304 and the display 302.

The GUI 304 may further contain multiple portions where each portion may be used for a specific purpose, such as sending and receiving gift messages via a communication service application, generating a gift message and interacting with a third party application, and loading an application, such as the GPS API. In one example, when a user (ABC) of the first computing device 300 requests access to a gift transfer application installed on the first computing device 300, the user (ABC) may be prompted to enter login details such as username, as displayed on the GUI 304 of the gift transfer application. Upon the entry of the username, a GPS server may generate a gift message 306 indicating a gift payment amount for a recipient (XYZ), as displayed on the GUI 304 of the gift transfer application, depicted in FIG. 3A.

The user (ABC) may have an option on one of the portions of the GUI 304 as depicted in FIG. 3B to add a challenge event comprising a task for the recipient (XYZ) in order to access information within the gift message. The task may be associated with going to a particular location at a particular date and time. Upon adding the challenge event corresponding to the gift message, the gift message is transmitted from the first computing device 300 to a database of the GPS system. A processor of the GPS system may then transmit the gift message to the recipient (XYZ), as depicted in FIG. 3C.

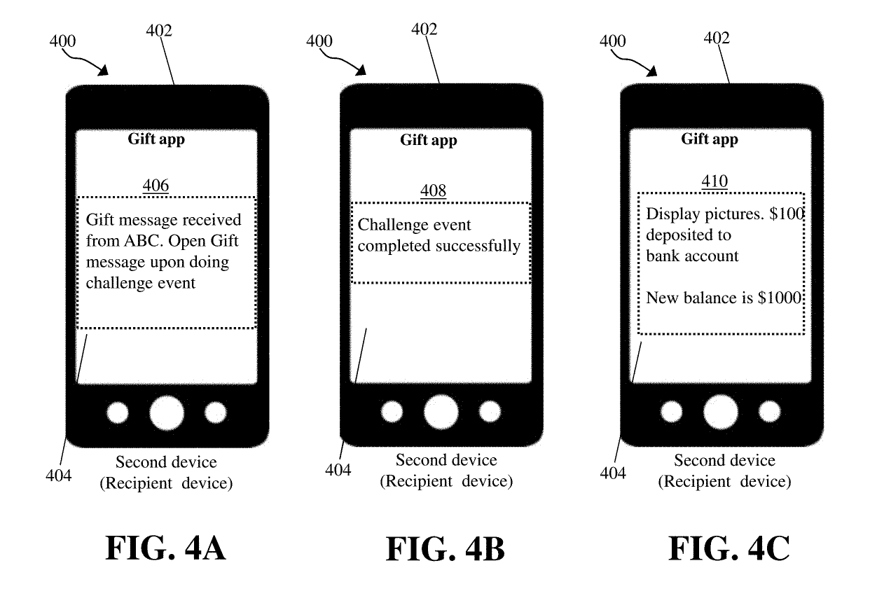

FIGS. 4A, 4B, and 4C illustrate a GUI 404 for presenting gift acceptance process when a user (XYZ) is accessing a gift transfer application on a second computing device 400 (such as a receiver device). FIGS. 4A, 4B, and 4C will be explained in conjunction with the FIGS. 3A, 3B, and 3C. The second computing device 400 has a display 402. The display 402 may include a cathode ray tube (CRT) display, a liquid crystal display (LCD), a plasma, or a light emitting diode (LED) display. The display 402 may provide some or all of the functionality of the GUI 404. The display 402 may be a touch-sensitive and/or a presence-sensitive display that can display the GUI 404 and detect input from a user in the form of user input gestures. A graphics subsystem may receive textual and graphical information and process the information for output to the display 402.

The display 402 may include the GUI 404 that allows a user to interact with the second computing device 400. The examples of the user interface 404 may include, but are not limited to, a keypad embedded on the second computing device 400, a keyboard, a mouse, a roller ball, buttons, stylus, or devices that allow the user to interact with the second computing device 400. In some examples, the second computing device 400 does not include the GUI 404, and the user interacts with the second computing device 400 with the display 402 (e.g., by providing various user gestures). In some examples, the user interacts with the second computing device 400 with the GUI 404 and the display 402.

The GUI 404 may contain multiple portions where each portion may be used for a specific purpose, such as sending and receiving gift messages via a communication service application, generating a gift message and interacting with a third party application, and loading an application, such as the GPS API. In one example, when a user (XYZ) of the second computing device 400 receives a notification for receipt of a new gift message from the user (ABC), the second computing device 400 requests access to a gift transfer application installed on the second computing device 400. The user (XYZ) may then be prompted to enter login information such as a username, as displayed on the GUI 404. Upon the entry of the username, a GPS server may display a gift message and challenge event associated with the gift message on the GUI 404, as depicted in the FIG. 4A.

The user (XYZ) may then complete the challenge event associated with going to the particular location. A processor of the second computing device 400, the first computing device 300, and/or the GPS system may track execution of the challenge event by the user (XYZ) by tracking a current location of the second computing device 400 using a global positioning system. Upon successful completion of the challenge event, the processor of the second computing device 400, the first computing device 300 of the user (ABC), and/or the GPS system may trigger and/or generate a notification regarding the completion of the challenge event, which may then be transmitted and displayed on the GUI 404 as depicted in the FIG. 4B.

The gift message may include a payment amount received and other items such as images, and is displayed on the GUI 404, as depicted in the FIG. 4C. Upon successful completion of the challenge event, the processor of the second computing device 400, the first computing device 300 of the user (ABC), and/or the GPS system may notify a payment-processing server regarding completion of the challenge event. The payment-processing server may then transfer the gift payment amount to an account of the user (XYZ), and the gift message is displayed on the GUI 404, as depicted in the FIG. 4C.

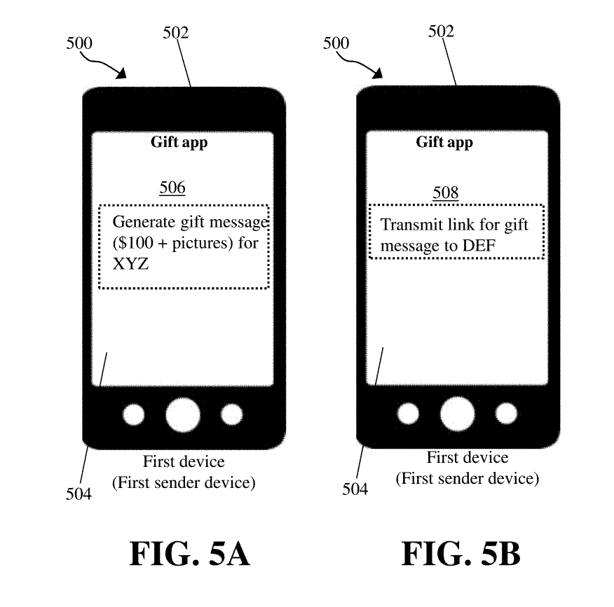

FIGS. 5A and 5B illustrate a GUI 504 for presenting gift generation process when a user (ABC) is accessing a gift transfer application on a first computing device 500. The first computing device 500 has a display 502 where the display 502 includes the GUI 504 that allows the user (ABC) to interact with the first computing device 500. The GUI 504 may further contain multiple portions where each portion may be used for a specific purpose, such as sending and receiving gift messages via a communication service application, generating a gift message and interacting with a third party application, and loading an application, such as the GPS API. When the user (ABC) requests access to a gift transfer application installed on the first computing device 500, the user (ABC) may be prompted to enter login details such as a username, as displayed on the GUI 504. Upon the entry of the username, a GPS server may generate a gift message 506 indicating a gift payment amount for a recipient (XYZ), as displayed on the GUI 504, depicted in FIG. 5A.

The user (ABC) of the first computing device 500 will have an option to add a challenge event comprising a task for the recipient (XYZ) in order to access information within the gift message 506. Upon adding the challenge event corresponding to the gift message 506 by the user (ABC), the gift message 506 is transmitted from the first computing device 500 to a database of the GPS system. A processor of the GPS system may then transmit a web link 508 for the gift message 506 to another user (DEF), as depicted in the FIG. 5B. Upon adding the challenge event corresponding to the gift message 506 by the user (ABC) of the first computing device 500, the gift message 506 is transmitted from the first computing device 500 to a database of the GPS system. A processor of the GPS system may then transmit the web link 508 to the gift message 506 to the recipient (XYZ) along with the user (DEF).

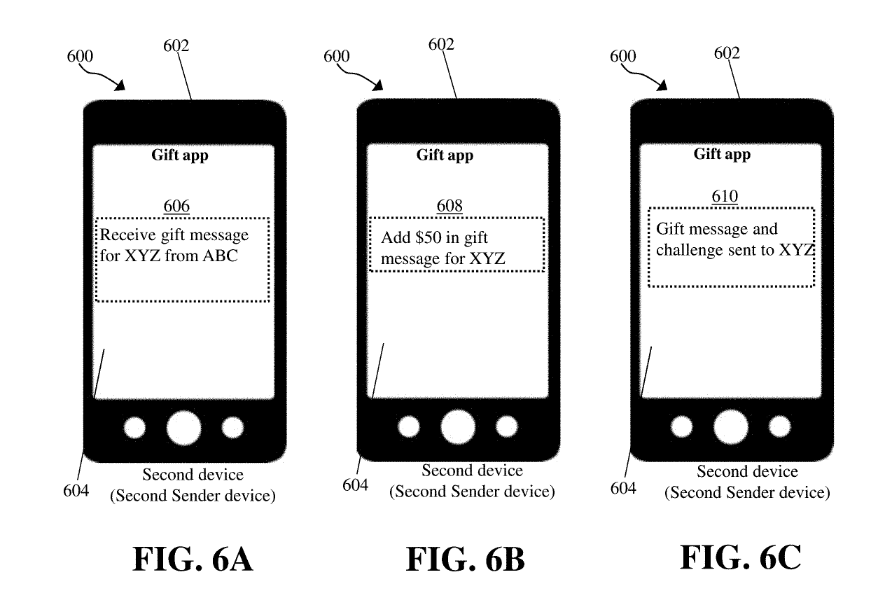

FIGS. 6A, 6B, and 6C illustrate a GUI 604 for presenting gift generation process when a user (DEF) is accessing a gift transfer application on a second computing device 600. FIGS. 6A, 6B, and 6C will be explained in conjunction with the FIGS. 5A and 5B. The second computing device 600 has a display 602 where the display 602 includes the GUI 604 that allows the user (DEF) of the second computing device 600 to interact with the second computing device 600. The user (DEF) receives a notification for receipt of a web link for a gift message from the user (ABC). The user (DEF) then clicks on the web link, and requests access to the gift transfer application installed on the second computing device 600. The user (DEF) may then be prompted to enter login information such as a username, as displayed on the user interface 604 of the gift transfer application. Upon the entry of the username, a GPS server may display a gift message 606 and a challenge event associated with the gift message received from the user (ABC), as displayed on the GUI 604 of the gift transfer application, as depicted in the FIG. 6A.

The user (DEF) may have an option on a portion of the GUI 604 as depicted in the FIG. 6B, to add items to the gift message or a new challenge event comprising a task for the recipient (XYZ), in order to access information within the gift message. Upon adding the new item or the challenge event corresponding to the gift message by the user (DEF), the gift message is transmitted from the second computing device 600 to a database of the GPS system. A processor of the GPS system may then transmit the gift message to the recipient (XYZ), as depicted in the FIG. 6C. When the gift message has been received by the recipient (XYZ), then also the user (ABC) or the user (DEF) may make any changes to the items within the gift message until the user (XYZ) completes the challenge event associated with the gift message to open the gift message.

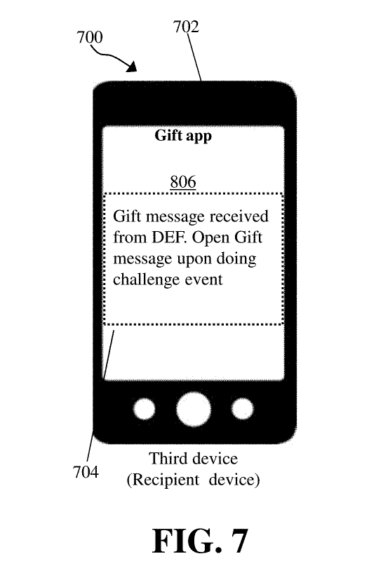

FIG. 7 illustrates a GUI 704 for presenting gift acceptance process when a user is accessing a gift transfer application on a third computing device 700. FIG. 7 will be explained in conjunction with the FIGS. 6A, 6B, 6C, 5A, and 5B. The third computing device 700 has a display 702 where the display 702 includes the GUI 704 that allows the user (XYZ) of the third computing device 700 to interact with the third computing device 700.

The user (XYZ) may receive a notification for receipt of a web link for a new gift message from the user (DEF) and the user (ABC). The third computing device 700 may then clicks on the web link and requests access to a gift transfer application installed on the third computing device 700. The user (XYZ) may then be prompted to enter login information such as a username, as displayed on the GUI 704. Upon the entry of the username, a GPS server may display a gift message 706 and a challenge event associated with the gift message in order to open the gift message 706 received from the user (DEF) and the user (ABC), as displayed on the GUI 704, depicted in the FIG. 7.

The user (XYZ) may then complete the challenge event. A processor of the third computing device 700, the first computing device 500 of the user (ABC), the second computing device 600 of the user (DEF), and/or the GPS system may track execution of the challenge event by the user (XYZ). Upon successful completion of the challenge event, the processor of the third computing device 700, the first computing device 500, the second computing device 600, and/or the GPS system may generate a notification regarding the completion of the challenge event, which may then be transmitted and displayed on the GUI 704. The gift message (indicating payment amount received and other items such as images etc.) is then displayed on the GUI 704. The gift message may be displayed on the GUI 704 according to an order determined by the user (XYZ). The gift message may be displayed on the user interface 704 according to an order determined by the user (ABC). The gift message may be displayed on the GUI 704 according to an order determined by the user (DEF). The gift message may be displayed on the GUI 704 using augmented reality.

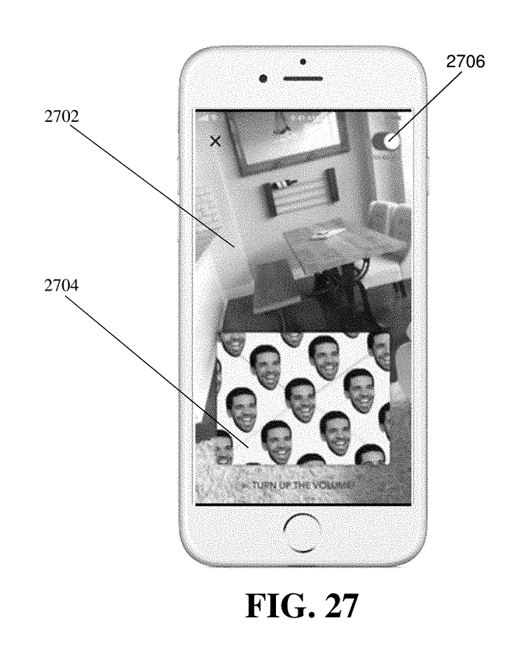

FIG. 27 illustrates an example of a gift message that is displayed with an augmented reality feature. A gift transfer application executing on a third computing device (e.g., recipient's computing device) of a recipient user may display a gift message (or a digital envelope that includes the gift message and multiple media elements selected by a sender user) as a view of a physical real-world environment whose elements are augmented by computer-generated or extracted real-world sensory input such as sound, video, graphics, and/or haptic data. The gift transfer application may activate a camera sensor associated or executing on the third computing device, and may display the gift message as a harmonious blend of an additional layer displayed with a representation of the recipient user surroundings. For example, as depicted in the FIG. 27, the gift transfer application may activate a camera (or otherwise receive camera data using an API executing on the third computing device), and may display the surroundings (as shown in the display 2702) of the recipient user. The gift transfer application may then display the gift message 2704 as an additional layer to the surroundings of the recipient user. In this way, the recipient user may view the gift message and the data received from the camera simultaneously. The gift transfer application may provide the recipient user an option (e.g., toggle 2706) to turn the augmented reality feature on or off. In some configurations, the gift message may be displayed as a digital envelope (e.g., a record or file that contains multimedia elements (e.g., pictures, videos, text).

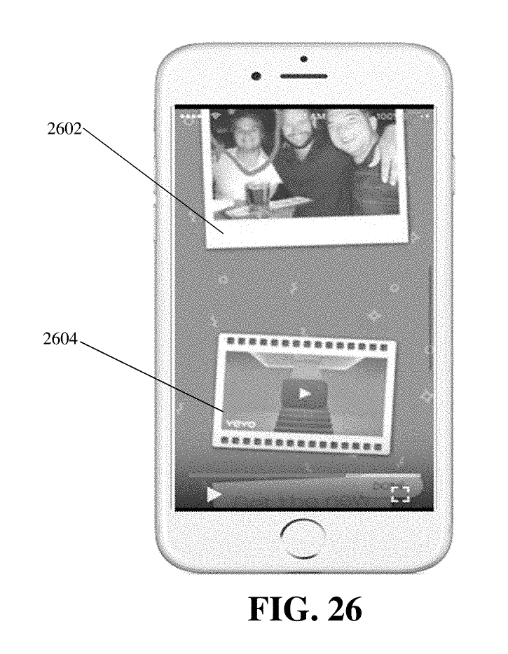

The gift message transmitting a digital envelope can be sent as a single message contains all of these elements rather than as separate messages, each containing a single multimedia element. Upon selecting (e.g., clicking, touching) the link in the message, the gift transfer application on the third computing device may display a GUI where the multimedia elements appear to be coming out of the digital envelope. Furthermore, the single GUI displays all of the multimedia elements. The multimedia elements may scroll along the screen, such as in a vertical direction away from the digital envelope graphic at a bottom side of the GUI. In some configurations, the recipient user may manually scroll through different multimedia elements. As depicted in the FIG. 26, a first item 2602 and a second item 2604 is displayed on the GUI of the third computing device in a pre-defined order.

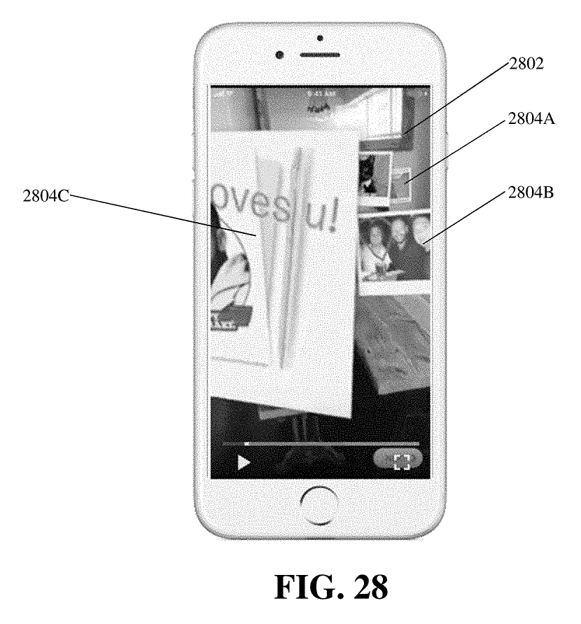

The gift transfer application may allow the recipient user to select one or more multimedia elements (from the digital envelope) to be displayed on the GUI of the third computing device. For example, the gift transfer application may display a representation (e.g., thumbnail) of multiple multimedia elements within the digital envelope, and allow the recipient user to select a displaying order for the multimedia elements. As depicted in the FIG. 28, the gift transfer application may display the thumbnails 2804A-C; when the gift transfer application receives an indication that the recipient user has engaged with (e.g., clicked on) any of the thumbnails, the gift transfer application may then display the particular multimedia element. The gift transfer application may also allow the recipient user to rearrange the order of the thumbnails. For example, the gift transfer application may allow the recipient user to scroll or drag each of the thumbnails 2804A-C in order to rearrange the display order of the thumbnails. As mentioned above, the gift transfer application may also display the thumbnails using the augmented reality technology. For example, the gift transfer application may display the thumbnails 2804A-C as an augmented layer to the camera data displayed (e.g., display 2802).

Referring back to the FIGS. 3A-7, upon successful completion of the challenge event, the processor of the third computing device 700, the first computing device 500, the second computing device 600, and/or the GPS system may notify a payment-processing server regarding completion of the challenge event. A payment-processing server may transfer the gift payment amount to an account of the user (XYZ), and then the gift message (indicating payment amount transferred and other items such as images etc.) is displayed on the GUI 704 of the third computing device 700.

The payment-processing server, on receiving inputs from a record server based on a payment authorization query sent to the record server upon completion of the challenge event, may determine that the user (ABC) and/or the user (DEF) does not have sufficient money to transfer, then the GPS server and/or a PPS server generates instructions for the first computing device 500 of the user (ABC) and/or the second computing device 600 of the user (DEF), to display message that informs the user that the user does not have sufficient funding to complete the payment request. The GPS server may generate instructions to user computing device to display options for the user (ABC) and/or the user (DEF) to cure the monetary deficiency. Options are generated by the GPS server and/or a PPS server based on the user (ABC) and/or the user (DEF) account information kept in the GPS database. For example, the user (ABC) and/or the user (DEF) have previously registered two bankcards with the GPS system and/or the PPS system. The GPS server then generates instructions to the first computing device 500 of the user (ABC) and/or the second computing device 600 of the user (DEF) to provide the user (ABC) and/or the user (DEF) with options to cure the funding deficiency using the bankcards.

### EXAMPLES

In one non-limiting example, a sender user may use a gift transfer application on a sender mobile device to generate a request for transmission of a gift message to a recipient user. A gift processing server may receive the request for the transmission of the gift message. The gift message may include a gift payment, media elements, and information associated with tasks. The tasks may include obtaining a first score on playing a first game and visiting a first location. The gift processing server via a payment-processing server may then withdraw funds corresponding to the gift payment from an account of the sender user, and transfer the funds into an escrow account. Upon withdrawal of the funds, the gift transfer application may generate a unique transaction token associated with the gift payment for the recipient user. The gift transfer application via the gift processing server may transmit the unique transaction token to the payment-processing server and a recipient mobile device of the recipient user. At the same time, the gift transfer application via the gift processing server may transmit the gift message to a gift transfer application on the recipient mobile device. The tasks within the gift message are then displayed on a GUI of the recipient mobile device. The recipient user then executes the tasks, and the recipient mobile device tracks the task activity of the recipient user. When the recipient user successfully complete all of the tasks, then a gift transfer application on the recipient mobile device transmits the unique transaction token to the payment-processing server. The payment-processing server matches the unique transaction token received from the recipient mobile device with a stored unique transaction token received from the sender mobile device. If both tokens have the same value, the payment-processing server transfers the funds from the escrow account into an account of the recipient user. At the same time, remaining contents on the gift message such as media elements are displayed on the GUI of the recipient mobile device. The recipient mobile device may then generate a receipt notification, and transmit the receipt notification to the sender mobile device. The receipt notification may include a personal message from the recipient user for the sender user.

In another non-limiting example, a first sender user may use a gift transfer application on a first sender mobile device to generate a first request for transmission of a first gift message to a recipient user. The first gift message may include a first gift payment, first media elements, and information associated with first tasks. A first task may include obtaining a first score on playing a first game. The first sender mobile device may transmit the first request to a gift processing server. A second sender user may use a gift transfer application on a second sender mobile device to generate a second request for transmission of a second gift message to the recipient user. The second gift message may include a second gift payment, second media elements, and information associated with second tasks. A second task may include visiting a first location. The second sender mobile device may transmit the second request to the gift processing server. The gift processing server may group the first request and the second request to generate a group gift message. During the generation of the group gift message, the gift processing server may generate a unique transaction token associated with both the first gift payment and the second gift payment for the recipient user. The gift processing server may include content of the first request, the second request, and the unique transaction token into the group gift message. The server may transmit the group gift message to a recipient mobile device of the recipient user. The server may also transmit the unique transaction token to a payment-processing server. The recipient user then executes various tasks, and the recipient mobile device tracks the task activity of the recipient user. When the recipient user successfully complete all of the tasks, then a gift transfer application on the recipient mobile device transmits the unique transaction token to the payment-processing server. The payment-processing server matches the unique transaction token received from the recipient mobile device with a stored unique transaction token received from the gift processing server. If both tokens have the same value, the payment-processing server make a transfer of the first gift payment and the second gift payment into an account of the recipient user, and remaining contents on the gift message such as the first and the second media elements are displayed in a predetermined order on a GUI of the recipient mobile device. The recipient user may scroll the GUI to view the first medial element and the second media elements in their predetermined order of arrangement. The recipient mobile device may then generate a receipt notification and transmit the receipt notification to the first sender mobile device and the second sender mobile device. The receipt notification may include a personal message from the recipient user for the first sender user and the second sender user. Although certain illustrative, non-limiting exemplary embodiments have been presented, various changes, substitutions, permutations, and alterations may be made without departing from the scope of the appended claims. Further, the steps of the methods described herein may be carried out in any suitable order, or simultaneously where appropriate. Thus, the scope of the disclosure should not necessarily be limited by this description.

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, may refer to the action and processes of a data processing system, or similar electronic device that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The embodiments may relate to an apparatus for performing one or more of the functions described herein. This apparatus may be specially constructed for the required purposes, or it may comprise a special purpose computer selectively activated or reconfigured by a computer program stored in the computer. Such a computer program may be stored in a machine (e.g., computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions for operations on a processor, and each coupled to a bus.

The embodiments described herein are described as software executed on at least one server, though it is understood that embodiments may be configured in other ways and retain functionality. The embodiments may be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein may be used to implement the systems and techniques according to this disclosure.

The embodiments may relate to an apparatus for performing one or more of the functions described herein. This apparatus may be specially constructed for the required purposes or be selectively activated or reconfigured by computer executable instructions stored in non-transitory computer memory medium or non-transitory computer-readable storage medium.

It is to be appreciated that the various components of the technology may be located at distant portions of a distributed network or the Internet, or within a dedicated secured, unsecured, addressed/encoded or encrypted system. Thus, it should be appreciated that the components of the system may be combined into one or more devices or co-located on a particular node of a distributed network, such as a telecommunications network. As will be appreciated from the description, and for reasons of computational efficiency, the components of the system may be arranged at any location within a distributed network without affecting the operation of the system. Moreover, the components could be embedded in a dedicated machine.

Furthermore, it should be appreciated that the various links connecting the elements may be wired or wireless links, or any combination thereof, or any other known or later developed element(s) that is capable of supplying or communicating data to and from the connected elements. The term “module” as used herein may refer to any known or later developed hardware, software, firmware, or combination thereof that is capable of performing the functionality associated with that element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Presently preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation may be combined with one or more features of any other implementation.

What is claimed is:

1. A method comprising:
receiving, by a server from a first application executing on a first mobile device, a request to transmit an electronic group message comprising at least a payment transfer request to a second mobile device of a second user, the payment transfer request comprising a first payment amount, a first payment account of a first user, a first media element, and a first payment criterion where a payment of the first payment amount is dependent upon satisfaction of the first criterion;
transmitting, by the server using a second application executing on the second mobile device, the electronic group message to a third mobile device, wherein the third mobile device updates the electronic group message by including a second payment amount, a second payment account of a third user, a second media element, and a second payment criterion where a payment of the second payment amount is dependent upon satisfaction of the first criterion and the second criterion;
generating, by the server, a unique transaction token corresponding to the electronic group message and transmitting the unique transaction token to a payment server associated with the first and second payment accounts;
upon withdrawing funds corresponding to the first and second payment amounts from the first and second payment accounts respectively, initiating, by the server, a transfer of the funds to an escrow account;
transmitting, by the server using a third application executing on the third mobile device, the electronic group message and the unique transaction token to the second mobile device, wherein the server displays the first and the second media elements in a predetermined order; and
upon the second mobile device satisfying the first and second criteria, instructing, by the server, the second mobile device to transmit the unique transaction token to the payment server, wherein the payment server initiates the transfer of the funds from the escrow account to a third payment account associated with the second mobile device, upon successful matching of the unique transaction token received from the server and the second mobile device.

2. The method according to claim 1, wherein the first payment criterion comprises a first set of tasks, wherein a task of the first set of tasks comprises visiting a first location.

3. The method according to claim 1, wherein the second payment criterion comprises a second set of tasks, wherein a task of the second set of tasks comprises obtaining a first score on a first game.

4. The method according to claim 1, wherein the predetermined order is determined by the first mobile device, and wherein the predetermined order is determined based on a type of content within the first and the second media elements.

5. The method according to claim 1, wherein the predetermined order is determined by the third mobile device, and wherein the predetermined order is determined based on a type of content within the first and the second media elements.

6. The method according to claim 1, further comprising transmitting, by the server, a payment transfer receipt on a graphical user interface of the first mobile device, the second mobile device, and the third mobile device upon successful transfer of the funds from the escrow account to the third payment account.

7. The method according to claim 1, further comprising transmitting, by the server, a return message received from the second mobile device, upon successful transfer of the funds from the escrow account to the third payment account to the first mobile device and the second mobile device, wherein the return message comprises a personal message of the second user.

8. A system comprising:
a server configured to:
receive a request from a first mobile device operated by a first user to transmit an electronic message comprising at least a payment transfer request to a second mobile device of a second user, the payment transfer request comprising a payment amount, a payment account of the first user, and a location-based criteria where a payment of the payment amount is dependent upon a satisfaction of the location-based criteria;
generate a unique transaction token corresponding to the electronic message and transmitting the unique transaction token to a payment server associated with the payment account of the first user;
upon withdrawing funds corresponding to the payment amount from the payment account of the first user, initiate a transfer of the funds to an escrow account;
upon transmitting the electronic message and the unique transaction token to the second mobile device, monitor location data associated with the second mobile device; and
upon the location data associated with the second mobile device satisfying the location-based criteria, instruct the second mobile device to transmit the unique transaction token to the payment server, wherein the payment server initiates the transfer of the funds from the escrow account to a payment account of the second user upon successful matching of the unique transaction token received from the server and the second mobile device.

9. The system according to claim 8, wherein the location-based criteria comprises a task of visiting a particular location.

10. The system according to claim 9, wherein task comprises visiting the particular location on a particular date at a particular time.

11. The system according to claim 8, wherein the electronic message comprises a first social media element and a second social media element, and wherein the first and the second media elements are displayed on a graphical user interface of the second mobile device upon the location data associated with the second mobile device satisfying the location-based criteria.

12. The system according to claim 11, wherein the first and the second media elements are displayed on the graphical user interface of the second mobile device in a predetermined order.

13. The system according to claim 12, wherein the predetermined order is determined by the first mobile device, and wherein the predetermined order is determined based on a type of content within first and the second media elements.

14. The system according to claim 8, further comprising transmitting, by the server, a return message received from the second mobile device upon successful transfer of the funds from the escrow account to the payment account of the second user to the first mobile device, wherein the return message comprises a personal message of the second user.

15. A method comprising:
receiving, by a server, a first request from a first mobile device of a first user to transmit a first electronic message to a recipient mobile device, the first electronic message comprising at least a first payment transfer request, the first payment transfer request comprising a first payment amount, a first media element, and a first payment criterion where a payment of the first payment amount is dependent upon a satisfaction of the first payment criterion;
receiving, by the server, a second request from a second mobile device of a second user to transmit a second electronic message to the recipient mobile device, the second electronic message comprising at least a second payment transfer request, the second payment transfer request comprising a second payment amount, a second media element, and a second payment criterion where a payment of the second payment amount is dependent upon satisfaction of the second payment criterion; and
transmitting, by a server, a group electronic message to the recipient mobile device, wherein the group electronic message comprises the first electronic message and the second electronic message displayed in a predetermined order on a graphical user interface of the recipient mobile device, and wherein the group electronic message displays a graphical indicator for the first payment criterion and the second payment criterion, and wherein a recipient user operating the recipient mobile device scrolls the first media elements and the second media element on the graphical user interface.

16. The method according to claim 15, wherein the first payment criterion comprises a first set of tasks, wherein a task of the first set of tasks comprises visiting a first location.

17. The method according to claim 15, wherein the second payment criterion comprises a second set of tasks, wherein a task of the second set of tasks comprises obtaining a first score on a first game.

18. The method according to claim 15, wherein the predetermined order is determined by the first mobile device, and wherein the predetermined order is determined based on a type of content within the first and the second media elements.

19. The method according to claim 15, wherein the predetermined order is determined by the second mobile device, and wherein the predetermined order is determined based on a type of content within the first and the second media elements.

20. The method according to claim 15, further comprising transmitting, by the server, a return message received from the recipient mobile device, upon successful transmission of the group electronic message to the recipient mobile device, wherein the return message comprises a personal message of the recipient user.
